(19) United States
(12) Patent Application Publication
(10) Pub. No.: US 2013/0107527 A1
(43) Pub. Date: May 2, 2013

(54) LUMINAIRES AND LIGHTING STRUCTURES

(71) Applicant: LSI Industries, Inc., Cincinnati, OH (US)

(72) Inventors: John D. Boyer, Lebanon, OH (US); James G. Vanden Eynden, Indian Springs, OH (US); Larry Akers, Clarksville, OH (US)

(73) Assignee: LSI INDUSTRIES, INC., Cincinnati, OH (US)

(21) Appl. No.: 13/621,510

(22) Filed: Sep. 17, 2012

Related U.S. Application Data
(63) Continuation-in-part of application No. 13/363,896, filed on Feb. 1, 2012.
Application No. 13/363,896 is a continuation-in-part of application No. 13/286,400, filed on Nov. 1, 2011.

(51) Int. Cl. F21V 7/00; B23P 11/00

(52) U.S. Cl. 362/241; 362/346; 29/428

(57) ABSTRACT

A luminaire is disclosed comprising one or more side members having one or more light modules associated therewith and defining a recess. The light module having one or more light sources, one or more light directing members, and a lens enclosing the light sources and directing members in the module. The light directing members can comprise reflector modules of different configurations to provide different light distributions from the associated one or more light sources. The light modules can be configured to cast different light distributions to combine to form the desired light distribution. The light modules can be designed or exchanged to create any desired light distribution from the same side members. The light module can comprise a tray such that the lens is sealed to the tray keeping moisture from entering the module.

### RELATED APPLICATION

This application is a continuation-in-part of U.S. patent application Ser. No. 13/363,896 filed Feb. 1, 2012, now pending, which is a continuation-in-part application of U.S. patent application Ser. No. 13/286,400 filed Nov. 1, 2011, now pending.

### FIELD OF THE DISCLOSURE

The present disclosure is directed generally to a luminaire for casting light to enlighten area. More particularly the present disclosure is directed to a luminaire constructed to efficiently direct light to areas desired to be lighted, while avoiding areas not desired to be lighted. The present disclosure also relates to a luminaire for efficiently managing heat generated by light sources. The present disclosure further relates to a versatile luminaire comprising one or more lighting modules and capable of producing different light distributions dependent upon the number or type of light modules provided to the luminaire. The present disclosure additionally relates to sealed lighting modules facilitating the previously mentioned versatility of a luminaire as well as providing simple replacement of broken, worn or outdated lighting modules.

### BACKGROUND OF THE DISCLOSURE

There is a need for a luminaire of the type described herein.

### SUMMARY OF THE DISCLOSURE

A luminaire comprising one or more side members, one or more light modules associated with one of the side members, the light module comprising one or more light sources, one or more light directing members, and a lens enclosing the light sources and directing members in the module, the light directing members redirecting light emitted from at least one of the one or more light sources to be perpendicular to the lens. The at least one light source can be an LED. One or more of the light directing members can be a reflector. One or more of the light directing members can be an optic lens. The side members can define a recess and the light modules direct light into the recess. The side members can comprise heat dissipation fins. A ceiling optionally extends between an upper edge of each of the side members. Preferably, no lens extends across a lower edge of the side members. In one embodiment, the luminaire has four side members. Optionally, at least one of the side members comprises no light module. Optionally, at least two of the light modules are configured to cast different light distributions. The light module can comprise a tray such that the lens is sealed to the tray keeping moisture from entering the module.

A luminaire comprising four side members, each side member having an inner face and the inner faces defining a recess closed on one end, one or more light modules associated with one or more of the side member inner faces, the light module comprising a tray, one or more light sources attached to the tray, one or more light reflectors or optic lenses associated with one or more of the light sources, and a lens enclosing and sealing the light sources in the module and the light directing members redirecting light emitted from at least one of the one or more light sources to be perpendicular to the lens. At least one light source can be an LED. The light module may be in surface contact with the side member to conduct heat away from the light module. One or more of the side members can comprise heat dissipation fins. The recess can be closed on one end by a ceiling extending between an upper edge of each of the side members. Preferably, no lens extends across a lower edge of each of the side members. One or more side members can comprise no light module. One or more of the light modules can be configured to cast different light distributions. A seal can exist between the tray and the lens to seal to the tray keeping moisture from entering the module. The light modules can be removable from the side members.

A light module for a luminaire, the light module comprising a tray, one or more light sources attached to the tray, one or more light directing members for directing light from the light sources, and a lens enclosing and sealing the light sources in the module, the light directing members redirecting light emitted from at least one of the one or more light sources to be perpendicular to the lens. The light sources can be LEDs. The light directing members can be reflectors. The light directing members can be an optic lens.

A reflector module for association with light sources in a luminaire, where the reflector module comprises a nest having a base, an upper reflector module wall and a lower reflector module wall defining a longitudinal trough-like configuration; the base defines a first row of light source apertures and a second row of light source apertures; a U-shaped longitudinal divider located between the first row of light source apertures and the second row of light source apertures, defining a first reflector trough and a second reflector trough in the nest. The longitudinal divider can have a straight upper wall adjacent to the first reflector trough, a straight lower wall adjacent to the second reflector trough and a straight crest connecting the longitudinal divider straight upper wall and the longitudinal divider straight lower wall. The base can further define a third row of light source apertures and a second longitudinal divider located between the second row of light source apertures and the third row of light source apertures, defining a third reflector trough in the nest. The longitudinal divider can be inverted such that the open end of the U-shape is directed toward the base of the nest. A first face of the longitudinal divider can define or approximate a curve directed toward the first row of light source apertures. The reflector module can also have a transverse divider between one or more adjacent pairs of light source apertures and extend from adjacent to the U-shaped longitudinal divider and the upper reflector module wall. The transverse divider can comprise a front face defining or approximating a curve to direct at least some light emitted from a light source located in the adjacent light source aperture back in the direction of the light source aperture. The transverse divider can comprise an approximately straight face oriented approximately perpendicular to the base of the nest.

A luminaire comprising light sources; one or more side members, each side member comprising a reflector module for association with the light sources, the reflector module comprising: a nest comprising a base, an upper reflector module wall and a lower reflector module wall defining a longitudinal trough-like configuration; the base defining a first row of light source apertures and a second row of light source apertures; a U-shaped longitudinal divider located between the first row of light source apertures and the second row of light source apertures, defining a first reflector trough and a second reflector trough in the nest. The longitudinal divider can have a straight upper wall adjacent to the first reflector trough, a straight lower wall adjacent to the second reflector trough and a straight crest connecting the longitudinal divider straight upper wall and the longitudinal divider straight lower wall. The base can further define a third row of light source apertures and a second longitudinal divider located between the second row of light source apertures and the third row of light source apertures, defining a third reflector trough in the nest. The longitudinal divider can be inverted such that the open end of the U-shape is directed toward the base of the nest. A first face of the longitudinal divider can define or approximate a curve directed toward the first row of light source apertures. The luminaire can also comprise a transverse divider between one or more adjacent pairs of light source apertures and extending from adjacent to the U-shaped longitudinal divider and the upper reflector module wall. The transverse divider can have a front face defining or approximating a curve to direct at least some light emitted from a light source located in the adjacent light source aperture back in the direction of the light source aperture. The transverse divider can comprise an approximately straight face oriented approximately perpendicular to the base of the nest. The luminaire can also comprise a further transverse divider having an approximately straight face oriented approximately perpendicular to the base of the nest.

A method of manufacturing a luminaire comprising the steps of: (a) providing a group of side members comprising at least a first side member and a second side member; (b) selecting a light distribution pattern for the luminaire; (c) selecting a first reflector module for association with light sources of the first side member to produce a first light distribution; (d) selecting a second reflector module for association with light sources of the second side member to produce a second light distribution different than the first light distribution; (e) assembling the group of side members such that the light distributions of the group of side members combines to approximate the selected light distribution pattern. The step of selecting a first reflector module for association with light sources of the first side member to produce a first light distribution can constitute selecting a first reflector module that would produce an IESNA Type 5 light distribution, and the step of selecting a second reflector module for association with light sources of the second side member to produce a second light distribution different than the first light distribution can constitute selecting a second reflector module that would produce an IESNA Type forward throw distribution. The step of providing a group of side members comprising at least a first side members and a second side member can comprise providing a first side member a second side member and a third side member when the step of selecting a first reflector module for association with light sources of the first side member to produce a first light distribution constitutes selecting a first reflector module that would produce an IESNA Type 5 light distribution, the step of selecting a second reflector module for association with light sources of the second side member to produce a second light distribution different than the first light distribution constitutes selecting a second reflector module that would produce an IESNA Type forward throw distribution, and further comprising the step of selecting a third reflector module for association with light sources of the third side member to produce an IESNA Type forward throw distribution. The method can further comprise selecting a forward throw area not underlying the luminaire to receive light from the luminaire and locating the first reflector module opposite to the forward throw area. The step of providing a group of side members comprising at least a first side members and a second side member comprises providing a first side member a second side member, a third side member and a fourth side member and further comprising the step providing no light distribution from the fourth side member.

### BRIEF DESCRIPTION OF THE DRAWINGS

Aspects and embodiments of the present disclosure may be more fully understood from the following description when read together with the accompanying drawings, which are to be regarded as illustrative in nature, and not as limiting. The drawings are not necessarily to scale, emphasis instead being placed on the principles of the disclosure. In the drawings:

FIG. 1 depicts a perspective view of a luminaire in accordance with the present disclosure, ornamental features of which are shown in Figures IDES through 14 DES;

FIG. 2 depicts a side view of the luminaire of FIG. 1;

FIG. 3 depicts a top view of the luminaire of FIG. 1;

FIG. 4 depicts a bottom view of the luminaire of FIG. 1;

FIG. 5 depicts a perspective view of one side member of the luminaire of FIG. 1;

FIG. 6 depicts an exploded view of the side member of FIG. 5;

FIG. 7 depicts a cross-sectional view of the luminaire of FIG. 1 and light ray traces emanating from one light source therein;

FIG. 8 depicts a portion of FIG. 7;

FIG. 9 depicts light rays traces emanating from a light source of the luminaire of FIG. 1;

FIG. 10 depicts a portion of FIG. 7 with light rays traces emanating from a light source;

FIG. 11 depicts a perspective view of a reflector of the luminaire of FIG. 1;

FIG. 12A depicts a perspective view of an alternative reflector to the reflector depicted in FIG. 11;

FIG. 12B depicts a longitudinal cross-sectional view of the reflector depicted in FIG. 12A;

FIG. 12C depicts a lateral cross-sectional view of the reflector depicted in FIG. 12A;

FIG. 12D depicts a longitudinal cross-sectional view of a portion of the reflector depicted in FIG. 12A with light tray traces;

FIGS. 13DES through 19DES depict a first embodiment of one ornamental design of the present disclosure, including perspective, front side, rear side, left side, right side, top and bottom views;

FIGS. 20DES through 26DES depict a second embodiment of the ornamental design of the present disclosure, including perspective, front side, rear side, left side, right side, top and bottom views;

FIG. 27 depicts a perspective view of an alternative embodiment reflector of the luminaire depicted in FIG. 1;

FIG. 28 depicts a perspective view of a baffle portion of the reflector depicted in FIG. 27;

FIG. 29 depicts a cross-section view of the baffle depicted in FIG. 28;

FIGS. 30A and 30B depict light rays traces emanating from a light source of the luminaire of FIG. 1 when having the alternative embodiment reflector of FIG. 27;

FIG. 31A depicts a perspective view of a first reflector module, while FIG. 31B depicts a top view of the reflector module of FIG. 31A and FIG. 31C depicts a cross-section taken through 31C-31C of FIG. 31B;

FIG. 32A depicts a perspective view of second reflector module embodiment, while FIG. 32B depicts a top view of the reflector module of FIG. 32A, FIG. 32C depicts a cross-section taken through 32C-32C of FIG. 32B, and FIG. 32D depicts a cross-section taken through 32D-32D of FIG. 32B;

FIG. 33A depicts a perspective view of a third reflector module embodiment, while FIG. 33B depicts a top view of the reflector module of FIG. 33A, FIG. 33C depicts a cross-section taken through 33C-33C of FIG. 33B, FIG. 33D depicts a cross-section taken through 33D-33D of FIG. 33B, and FIG. 33E depicts a cross-section of a downward throw transverse divider of FIG. 33B;

FIG. 34A depicts a perspective view of a fourth reflector module embodiment, while FIG. 34B depicts a top view of the reflector module of FIG. 34A, FIG. 34C depicts a cross-section taken through 34C-34C of FIG. 34B, FIG. 34D depicts a cross-section taken through 34D-34D of FIG. 34B, and FIG. 34E depicts a cross-section of the longitudinal divider of FIG. 34B; and

FIG. 35A depicts a perspective view of a fifth reflector module embodiment, while FIG. 35B depicts a top view of the reflector module of FIG. 35A, and FIG. 35C depicts a cross-section taken through 35C-35C of FIG. 35B.

The embodiments depicted in the drawing are merely illustrative. Variations of the embodiments shown in the drawings, including embodiments described herein, but not depicted in the drawings, may be envisioned and practiced within the scope of the present disclosure.

### DETAILED DESCRIPTION

Aspects and embodiments of the present disclosure provide luminaires and elements thereof. Luminaires according to the present disclosure can be used for new installations or to replace existing luminaires or elements thereof. Use of such luminaire and lighting elements can afford reduced energy and maintenance as well as reduced installation time and costs when compared to existing techniques. The versatility of the luminaire and elements of the present disclosure also afford efficiencies to manufacturers, installers and end-users of such luminaire through lower manufacturing and inventory costs as well as the ability of the end-user to upgrade, adapt or fix the luminaire in the field.

While the preferred embodiment uses light emitting diodes (“LEDs”) as light sources, other light sources may be used in addition to LEDs or instead of LEDs within the scope of the present disclosure. By way of example only, other light sources such as plasma light sources may be used. Further, the term “LEDs” is intended to refer to all types of light emitting diodes including organic light emitting diodes or “OLEDs”.

While the luminaire depicted in the Figures is generally applicable to any application that would benefit from indoor or outdoor area lighting, it is well-suited, in one example, for application to parking lots and garages. In other embodiments the teachings of this disclosure are applicable to, for example, street lighting.

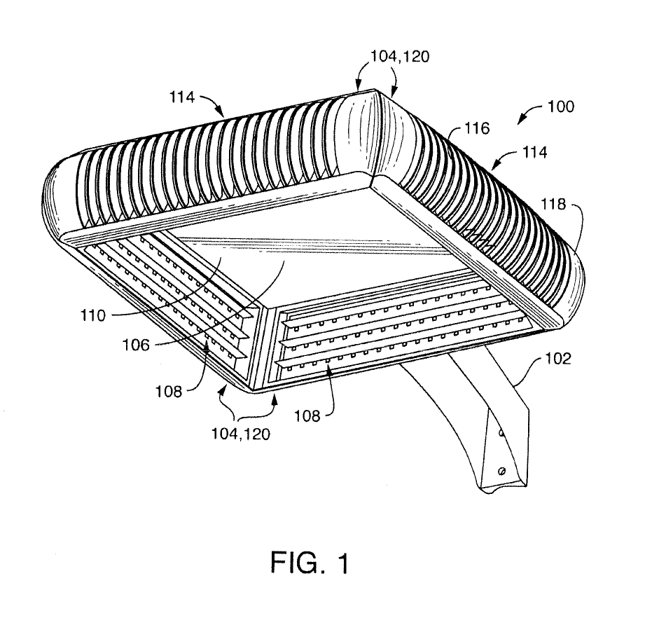

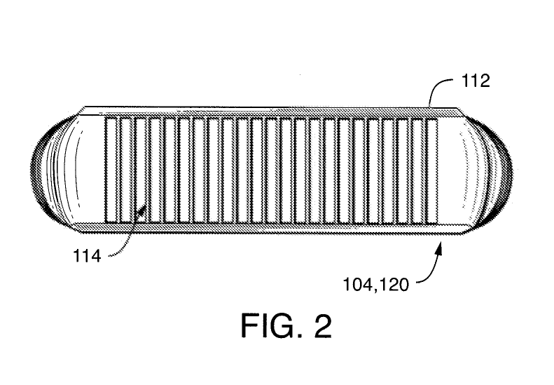

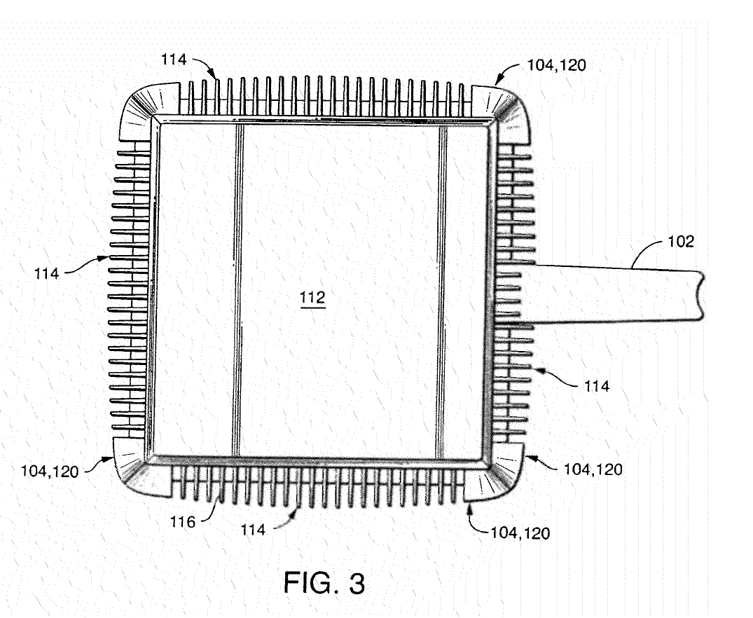

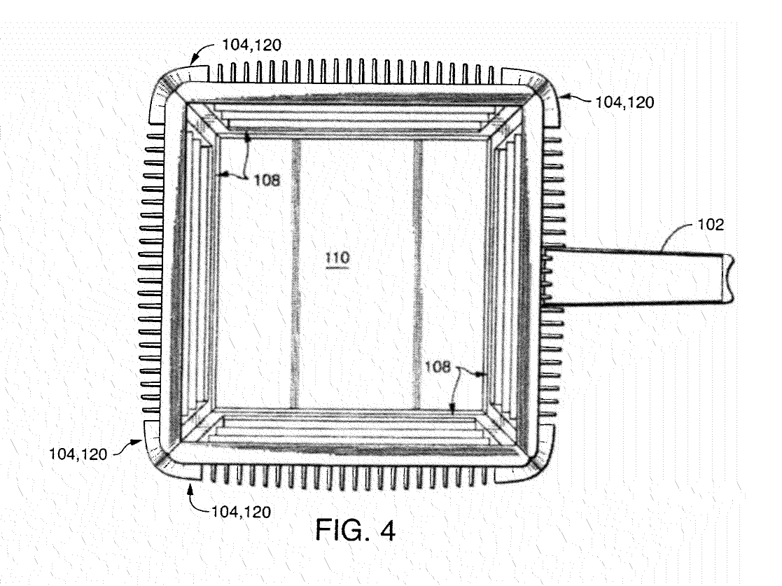

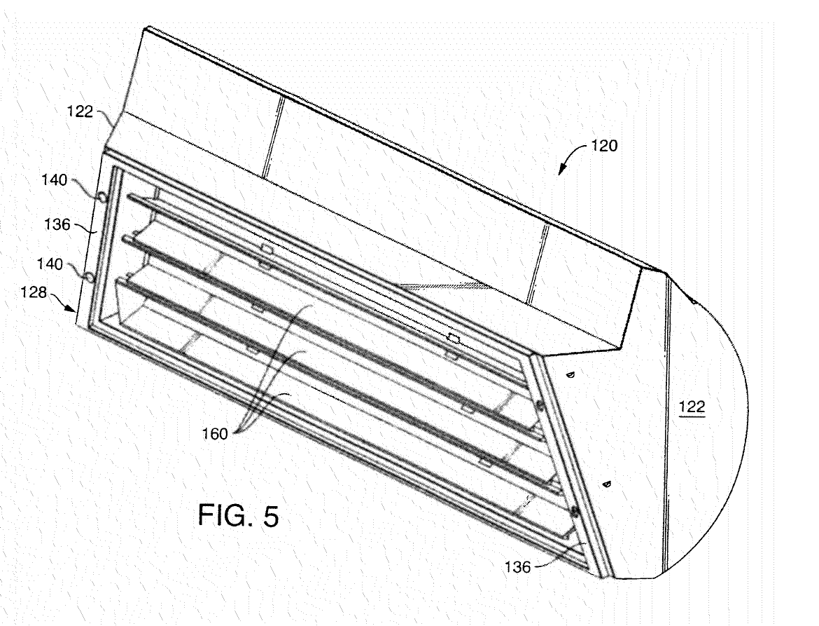

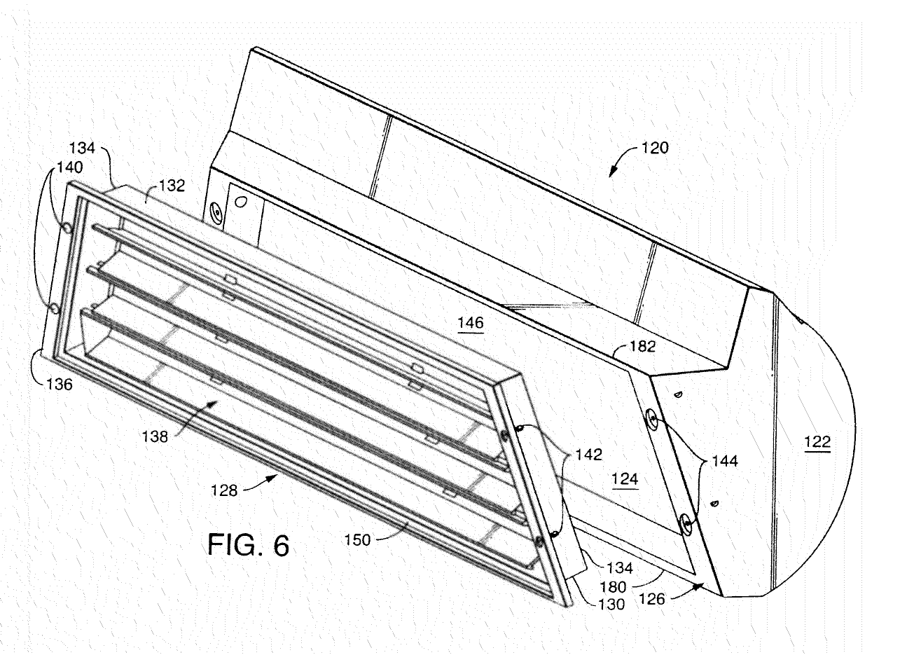

FIG. 1 depicts a perspective view of a luminaire 100, in accordance with the present disclosure. A mounting bracket 102 extends from luminaire 100 for mounting to, for example, a wall of a building. Other applications and corresponding mounting are contemplated, such as atop of pole, where one or more luminaires 100 may be mounted. The luminaire 100 could also be hung from a ceiling facing downward (as depicted) or facing upward to cast light toward the ceiling.

The luminaire 100 depicted in FIG. 1 is comprised of four sides 104 arranged in a rectangular (depicted as square) configuration creating an internal recess 106 defined by the inside faces of the four sides 104. The inside faces of each of the four sides 104 comprise a light bay 108. The inside faces of each of the four sides 104 is angled outward as they extend downward, directing the light cast by the light bays 108 inward toward the recess 106 and downward toward a target area to be lighted. In alternative embodiments, the inside faces are not angled, but the light emitted from the light bays 108 is directed downward at an angle such as by orientation of the light source, reflectors or optics, or any combination thereof.

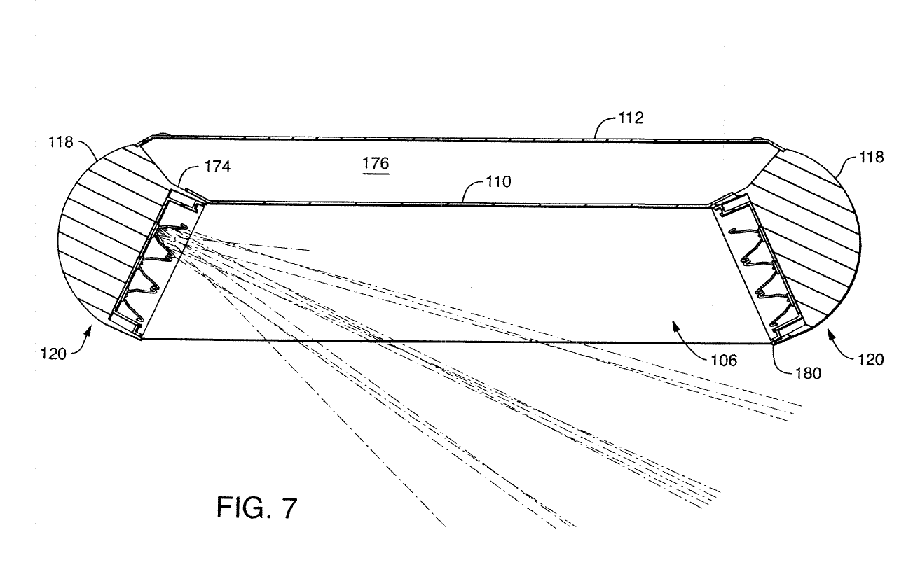

The luminaire 100 further comprises a ceiling 110 closing the top of the recess 106. Optionally, a roof 112 (see e.g. FIG. 7) can extend above the ceiling between the four sides 104 to protect the recess 106 from wind, rain, snow or other weather elements.

One or more of the four sides 104 can have heat dissipation features 114 to increase heat dissipation to the ambient environment via convection and/or radiation. In the depicted luminaire 100, the heat dissipation features 114 are comprised of a plurality of fins 116. Each fin 116 extends vertically such that the planes defined by each of its opposing faces, which comprise the majority of their surface area, are perpendicular to the ground, floor or area desired to be lighted. In this orientation, the luminaire 100 takes advantage of the ambient upward air currents caused by the rise of the warmer air due to dissipation of heat from the luminaire to the surrounding air. That is, the vertical orientation of the fin 116 causes the upward flow of air to pass across a majority of the fin surface area, increasing the convective heat transfer to the surrounding environment.

Each side 104 of the luminaire 100 comprises a rounded outer side 118 along its length. As depicted, each of the plurality of heat dissipation fins 116 extends from a base located at a point inward of the outer side 118 to a tip located at the outer side 118 and the tip comprises the same rounded configuration as the remainder of the side 104. The deeper fin 116 extends, the more heat transfer surface area that is created. It will be understood by those of ordinary skill in the art that the number and size (e.g. depth) of the fins can be varied to suit the needs of a luminaire depending on the need for lumens generated and the corresponding amount of heat generated to create those lumens. The type of light source and its sensitivity to heat will also factor into this calculation. For example, LEDs operate more efficiently and have greater longevity when operated at low temperatures. Thus, maximum cooling capabilities may be desired for a luminaire using one or more LEDs as light sources.

In one embodiment, the depicted luminaire 100 is comprised of four side members 120 (depicted in FIGS. 5 and 6 and in cross-section in FIGS. 7-8 and 10) each constituting one of the four sides 104 of the luminaire 100. In this embodiment, each side member 120 has opposing ends 122. The ends 122 of the depicted side members 120 are flat and angled at 45° to the length of the side member 120 such that when four side members 120 are placed end 122 to end 122, the four side members 120 constitute a rectangular (depicted as square) luminaire 100. Constructing each end 122 at a 45° angle in this manner provides the advantage of being able to create a square luminaire 100 from four identical side members and a non-square rectangular luminaire from two identical longer side members and two identical shorter members. Of course, other angles can be used to accomplish the other features of the luminaire of the present disclosure.

The side members 120 are secured one to the others at their ends 122. In one embodiment, the ends are bolted to one another through holes in their ends 122 in any known manner. Other manners of securing the ends 122 to each other, including for example intervening brackets, are also contemplated. In other embodiments, the ends 122 are not flat, but instead have projections and/or complementary indentations (not depicted) to align the side members 120 to each other properly, which provides a more aesthetic luminaire and ensures proper placement and orientation of the light sources for a proper light distribution from the luminaire.

The side members 120 can be of a cast, folded sheet metal or other construction. In one embodiment, the side members 120 are cast aluminum.

In the depicted embodiment, the side members 120 comprise a light module recess 124 in a face 126 that faces the recess 106 when assembled into the luminaire 100. The light module recess 124 accommodates a light module 128 which provides the light bay 108 of the luminaire 100. When assembled together, the side members 120 are configured so that the face 126 angles outward as it extends downward. This assists in directing light emitted from the light module in the desired direction, as will be discussed in more detail below. It also results in the face 126 of the side members 120 having a trapezoidal face, wider at the bottom and narrower at the top.

The depicted light module 128 is configured as a tray having a lower edge 130, and upper edge 132 and left and right edges 134. To maximize use of the side member face 126, the light module 128 is trapezoidal, having the lower edge 130 longer than the upper edge 132, and the left and right sides 134 angled in a trapezoidal configuration. The light module 128 comprises a flange 136 extending from the left and right sides 134 at the front thereof. The light module lower edge 130, upper edge 132 and left and right edges 134 circumscribe a light bay cavity 138 extends reward of the flange 136 to house the light bay. The flanges 136 comprise apertures 140 to receiving screws 142 or the like permitting securement of the light module 128 to the side member 120 via holes 144 in the side member face 126. In one embodiment, the backside of the light bay cavity is of substantially the same configuration as the front face 146 of the light module recess 124 in order to maximize surface contact there between, allowing maximum heat transfer from the light module to the side member 120, including the heat dissipation features 114, 116. It is contemplated that fins or other surface-area increasing features could exist on the back of the light module 128 with complementary receiving features on the side member front face 146 to increase surface area contact between the two.

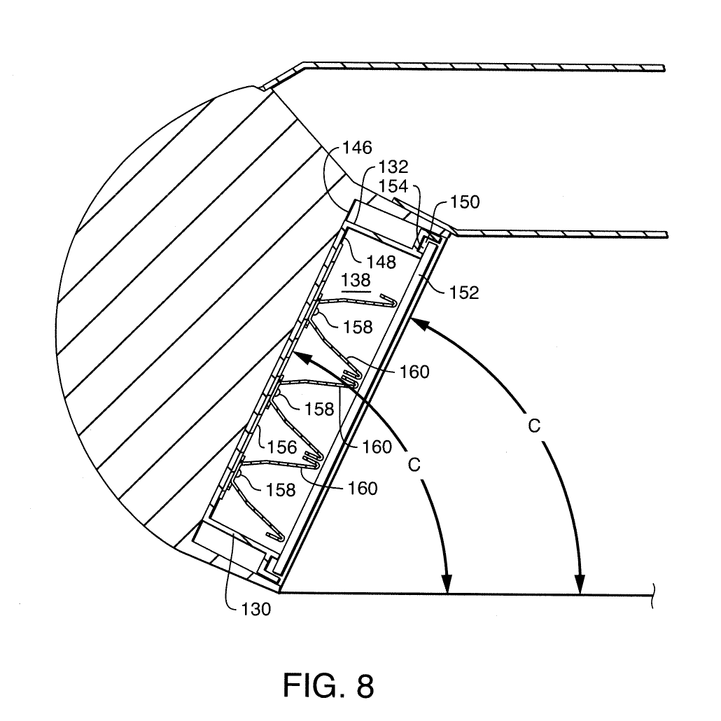

The light bay cavity 138 of the light module 128 comprises a base 148 (see FIG. 8) surrounded by the lower 130, upper 132 and side 134 edges of the light module 128. The front of the light module 128 defines a recess 150 to receive a lens 152 at the front of the light module 128. A cavity 154 may be formed where the lens 152 interfaces with the light module 128 to provide for a lens gasket to seal the light bay cavity 138, preventing moisture, dirt, etc. from entering. In this configuration, the light modules 128 are self-contained light modules that can be manufactured, inventoried and/or shipped separately from the remainder of the luminaire 100 for quick and simple installation. In one embodiment, the cavity 154 can be provided with gasketing adhesive that both adheres the lens 152 to the light module tray and creates a seal between the two.

In an alternative light module configuration, the lens is secured to the flange such that the light module is placed in the light module recess and then the lens and flange screwed over the remainder of the light module against the gasket in the gasket cavity to secure the entire light module in the light module recess.

A printed circuit board (“PCB”) 156 is mounted on the light bay cavity base 148 providing a plurality of LEDs 158. The LEDs 158 are aligned into three rows. While the depicted embodiment shows all LEDs 158 on a single PCB 156, other configurations are contemplated within the scope of this disclosure.

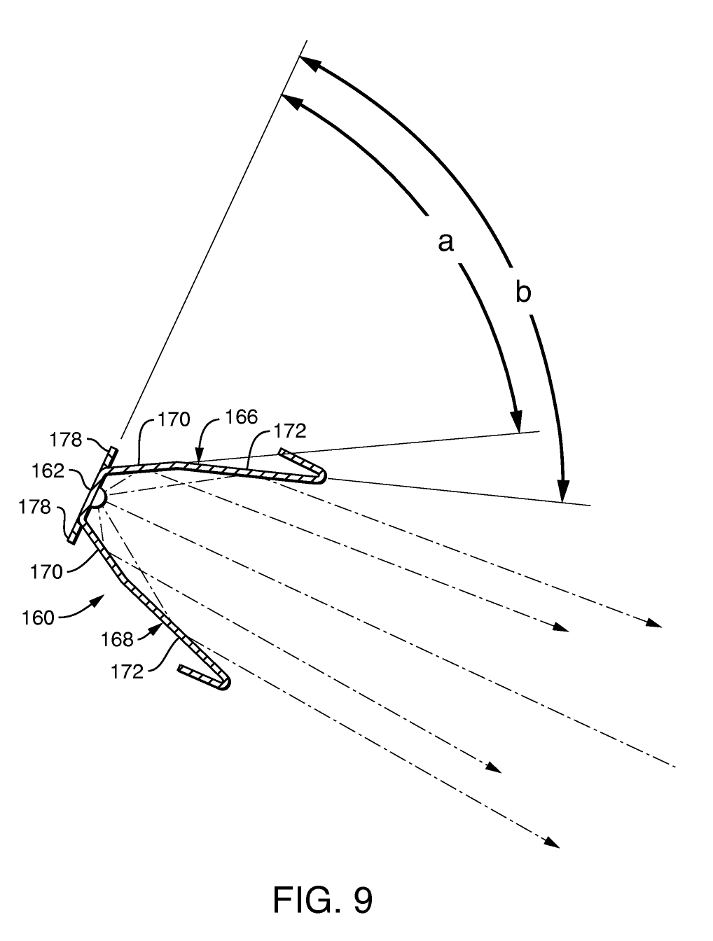

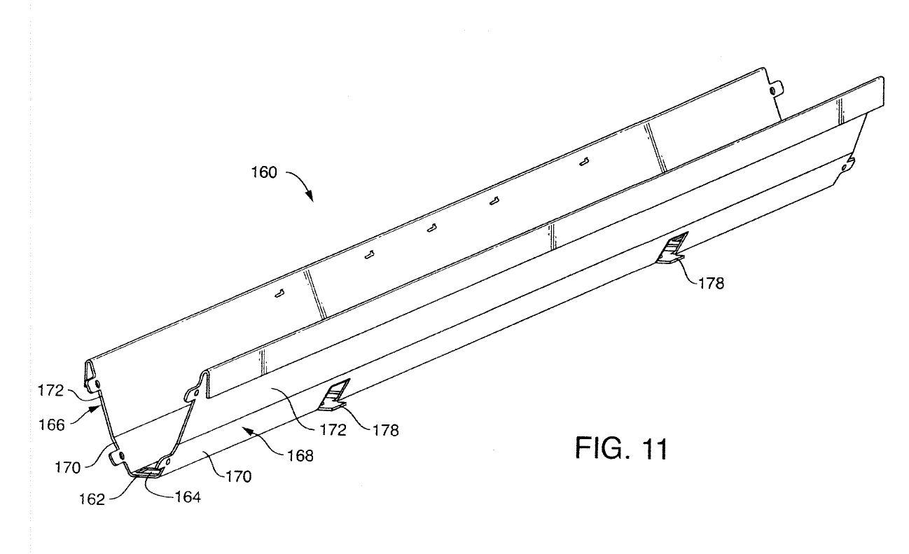

The light modules 128 further comprise a reflector 160 over each row of LEDs 158 to direct the light emitted from the LEDs 158. FIG. 9 depicts a cross-sectional view of a reflector depicted in FIGS. 7-8 and FIG. 10 depicts a close-up view of the reflectors 160 in one side member 120 of FIG. 7. FIG. 11 depicts a perspective view of the reflector 160 of FIG. 9 separated from the remaining elements of the luminaire 100. In the depicted embodiment, reflectors 160 comprise a base 162 with a series of holes defining apertures 164 through which the LEDs 158 protrude when the base 162 is placed on the PCB 156. Tabs 178 may extend from the base to assist in securing the reflector 160 to the light module 128. First and second member 166, 168 extend from opposing sides of the reflector base 162. The first and second members 166, 168 each comprise a straight proximate angled portion 170 extending from the base 162 and a straight distal angled portion 172 extending from the proximate angled portion 170. The proximate and distal portions 170, 172 of the first and second member 166, 168 are configured to direct the light emitted from the LEDs 158 as desired. It is contemplated that more or fewer portions at different angles or curvatures may be used to achieve the desired light distribution. It is contemplated that optical lenses may be used in addition to, or in replacement of, reflectors 160 to achieve the desired light distribution.

As depicted in FIG. 9, the depicted reflectors 160 orient the proximate angled portions 170 of the reflectors 160 at an angle a of 60° from a plane defined by the PCB and the second angled portions 172 at an angle b of 71° from that plane. When used in conjunction with a variety of different types of LEDs (e.g. any LED providing a lambertian distribution, such as a Nichia NVSW219A) this reflector configuration collimates the light emitted from the LEDs 158 such that all, or substantially all, of the light emitted from the LEDs 158 leaves the reflector 160 substantially perpendicular to the PCB 158 as shown by the light ray traces in FIG. 9. Other manners of collimating light emitted from these or different LEDs are also contemplated.

As discussed above, the depicted light modules have a trapezoidal shape. In this configuration, the row of light sources 158 and corresponding reflector is longer at the bottom of the trapezoidal shape of the light module 128 in order to maximize the light sources 158, and thus lumen capability, available in the space allowed. Accordingly, the reflectors 160 will be of increasing length from the top row to the bottom row.

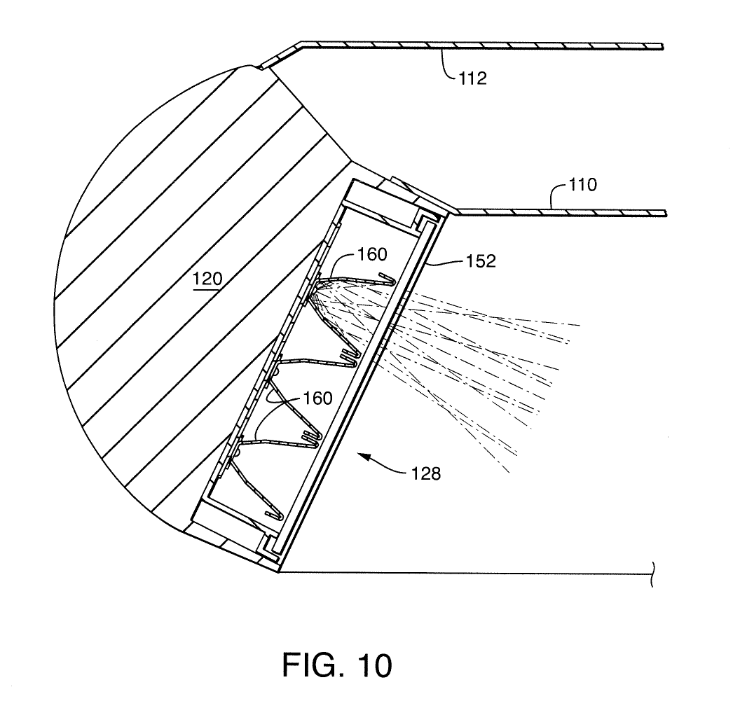

When these reflectors 160 are incorporated into the light modules 128, the lens 152 is preferably substantially parallel to the light module base 148, and therefore the PCB 156, such that the light rays exiting the reflectors 160 reach the lens 152 approximately perpendicular to the plane defined by the lens 152, as shown in FIG. 10. Directing the light rays such that they address the lens 152 approximately perpendicular to the plane it defines substantially reduces internal reflection of such light rays by the lens 152. The configuration of the light module 128 therefore substantially reduces lumen loss due to internal reflection at the lens 152. Because the light module is a factory assembled module, the reduced or eliminated internal reflection is guaranteed throughout the lifetime of the light module 128 and any luminaire comprising such a light module 128 will recognize increased efficiency as a result.

In the depicted embodiment, the lens 152 of the light module 128 is angled at an angle c of approximately 65° from horizontal as shown in FIG. 8. It is common to place a lens horizontally across the lowermost portion of a luminaire. On the luminaire disclosed herein, such a lens would extend across and between the lowermost portions of the side members. In such a configuration, the collimated light rays leaving the light module 128 would address such a horizontal lens at an angle of approximately 65°. It is believed that at such an angle of incidence, approximately 10% of the light rays would be reflected off of the lens, keeping those light rays inside the luminaire, thus cutting the lumen output by 10% and creating energy inefficiencies. The luminaire 100 does not comprise any lens other than lenses 152 of the light modules 128, through which collimated light rays pass perpendicularly, thus minimizing lumen loss due to internal reflection and maximizing energy efficiencies.

By constructing the light module 128 as a self-contained, preassembled module, the light module 128 allows assembly and/or installation of a luminaire without those elements contained in the light module 128, which are typically the most fragile elements in the luminaire. For example, the luminaire could be assembled and mounted in place, leaving installation of only the light modules 128. The light modules 128 could then be wired and screwed into place to preserve the integrity of the light module 128 and its elements. Additionally, the self-contained, preassembled character of the light module 128 allows for simple replacement if one or more elements of the light module 128 is damaged; for example, the malfunction or expiration of an LED 158. Use of the light modules 128 also permits upgrading the LEDs 158 when newer, better or otherwise different LEDs or other light sources are later developed or desired.

Returning to FIG. 7, wiring (not depicted) to provide power to the LEDs 158 can extend out of the light module 128, preferably through the upper edge 132. When installed in a side member 120, the upper edge 132 of the light module 128 resides adjacent to an upper lip 174 of the side member 120. A hole (not depicted) can be provided in the upper lip 174 allowing wiring to be extended there through and into a space 176 defined between the ceiling 110 and the roof 112 where wiring exists to provide power to each of the light modules 128 in the luminaire 100. Drivers and/or ballast (not depicted) can also be located in this space 176.

The depicted luminaire 100 is configured with four like side members 120, each having a like light module 128. As depicted in FIG. 7, the four side members 120, in conjunction with the ceiling 110, form a recess 106. The light modules 128 are located on the side members 120 facing inward toward the recess 106. As shown in FIG. 8, the front face 146 of the light module recess in the side members 120 preferably forms an angle c of approximately 65° with horizontal such that the light rays emitted from the light modules 128 are projected at approximately 65° below horizontal. Because the light modules 128 face inward toward the recess 106, it is preferred that the side members 120 be of a length sufficient to allow all light rays emitted from each light module 128 at the desired angle c of (65° in the depicted embodiment) to clear the opposing side of the luminaire. That is, the length of the side members 120 are preferably great enough such that the uppermost light rays emitted from the light modules clear the lowermost portion of the opposing side member 120, as depicted in FIG. 7. The side members in the depicted embodiment have a length of 22.8 inches along the lower edge 180 of its face and 18.3 inches along the upper edge 182 of its face with the face angled at 65° from horizontal, as previously discussed and the uppermost LED 158 located 3.9 inches above the lower edge 180 of the side member face. In this configuration, substantially all of the light rays emitted by each of the four light modules 128 clear the lower edge 180 of the opposing side member 120 and substantially all of the light emitted by the LEDs 158 escape the luminaire 100.

In the depicted configuration, the luminaire 100 provides a light distribution defined by the Illuminating Engineering Society of North America (“IESNA”) as a Type V light distribution. In addition to the benefits described above, the use of light modules 128 in the luminaire 100 disclosed herein facilitates providing different light distributions by using fewer and/or one or more different light modules in the luminaire 100 as otherwise described herein. For example, while the depicted luminaire 100 provides a light distribution pattern approximating an IESNA Type V light distribution, the same luminaire could approximate a different light distribution by removing or replacing one or more of the light modules 128 with a light module emitting fewer or greater lumens, or emitting light rays in a different direction through use of different reflector configurations and/or optic lenses.

In one example, removing the light module 128 from one side member 120 would create a luminaire emitting light in three directions that would approximate an IESNA Type IV light distribution commonly referred to as a “Forward Throw” distribution. This exemplary configuration would leave three side members 120 having light modules 128 and one side member 120 without a light module 128. By placing the one side member 120 without a light module 128 in the direction of the forward throw, the light module 128 of the opposing side member 120 will cast light in the forward throw direction and the light modules 128 of the two adjacent side members 120 will cast light in the two directions transverse to the forward throw direction creating a T-like light distribution approximating an IESNA Type IV light distribution. Additional LEDs could also be added to the light module casting light in the forward throw direction to increase lumen output and fewer LEDs could be added to the light modules casting light in the transverse directions to decrease lumen output to adjust the light distribution as necessary or desirable to bring the light distribution closer to the IESNA Type IV distribution, or other desired distribution. Alternatively, the number of LEDs could remain the same, but the LEDs of the respective light modules driven differently to increase or decrease lumen output as desired.

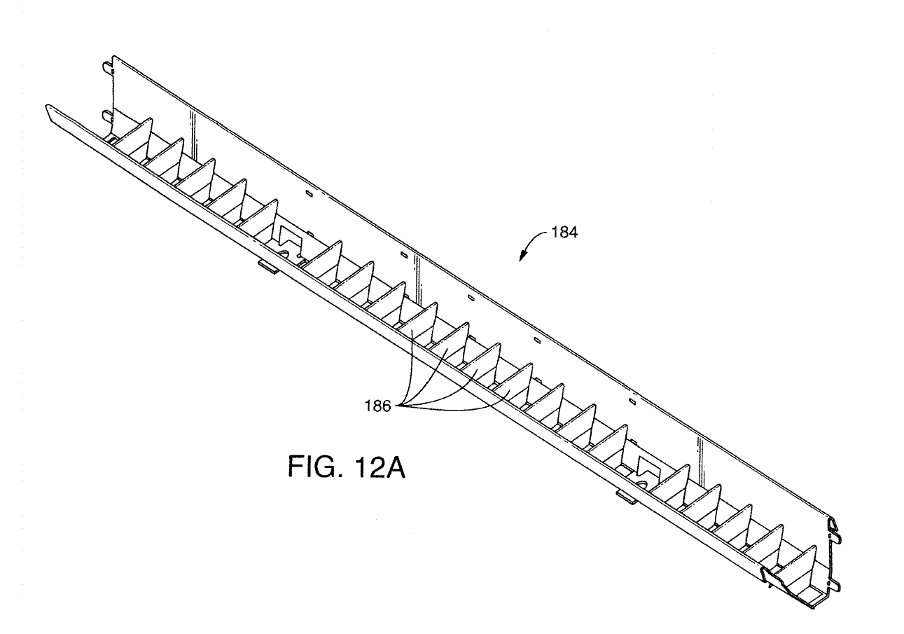

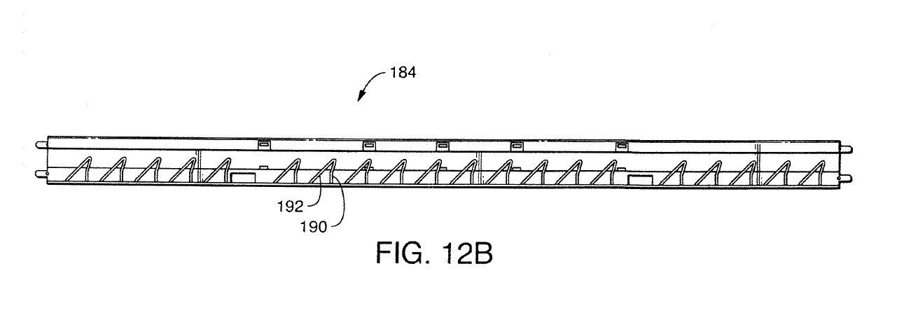

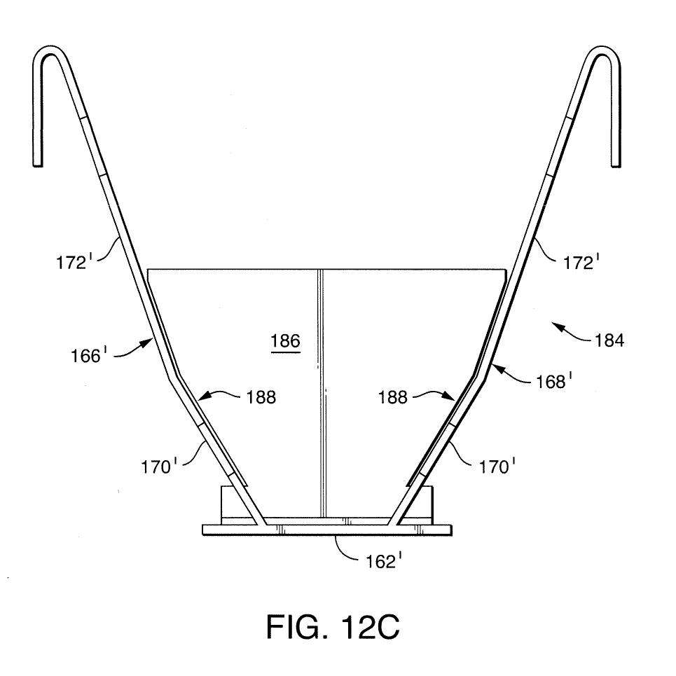

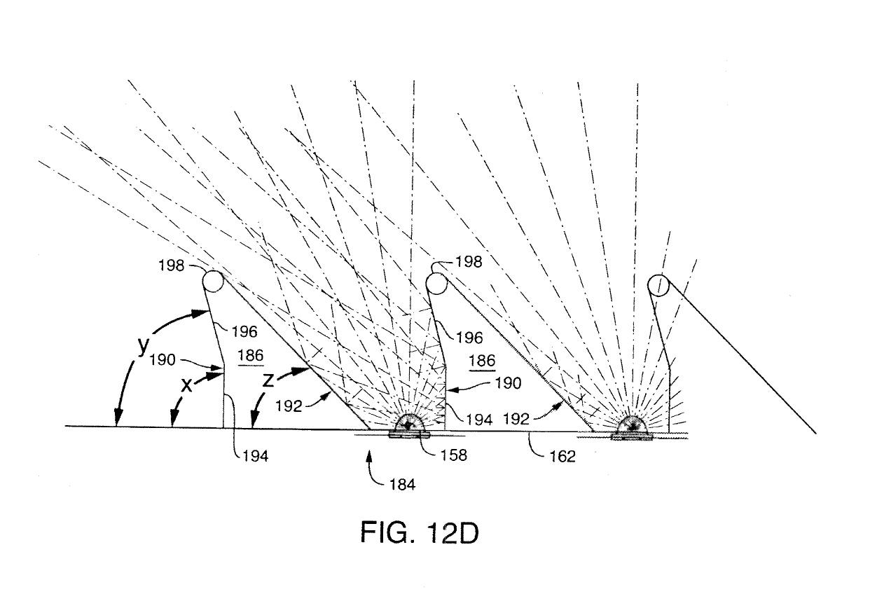

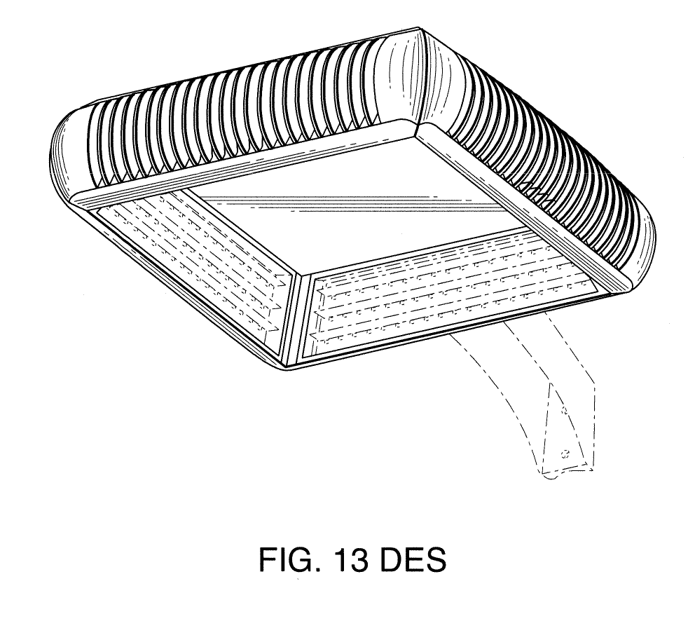

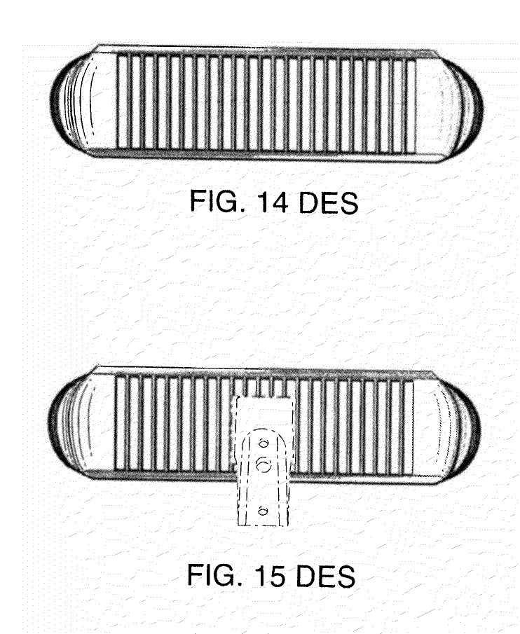

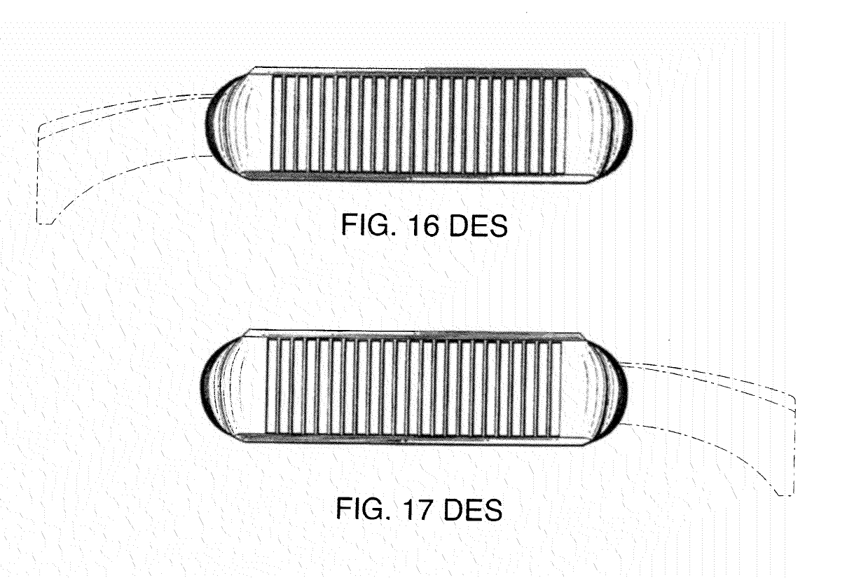

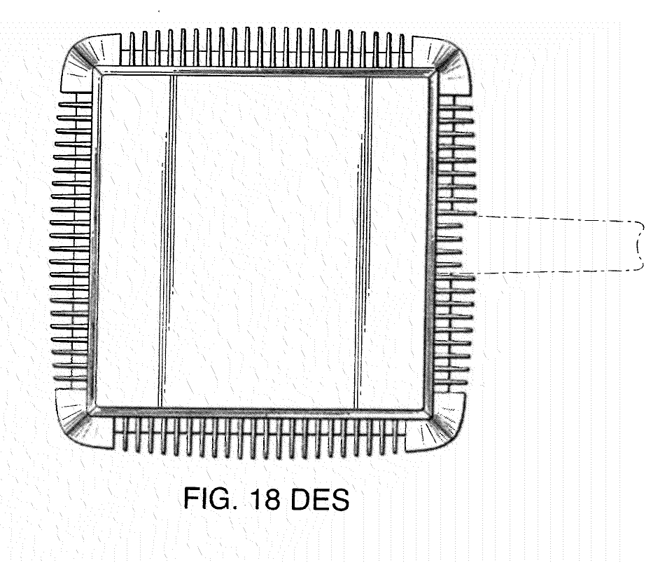

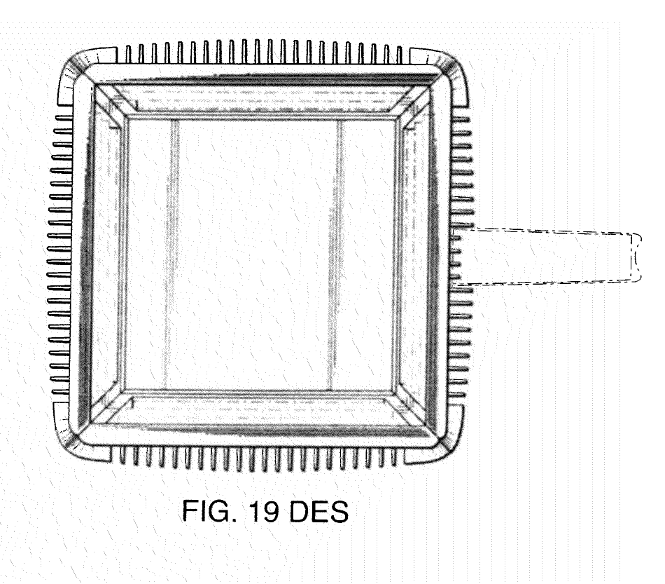

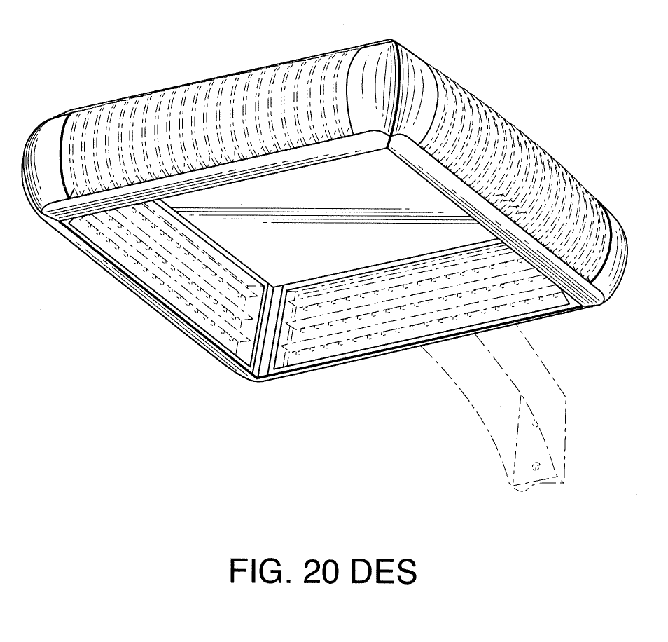

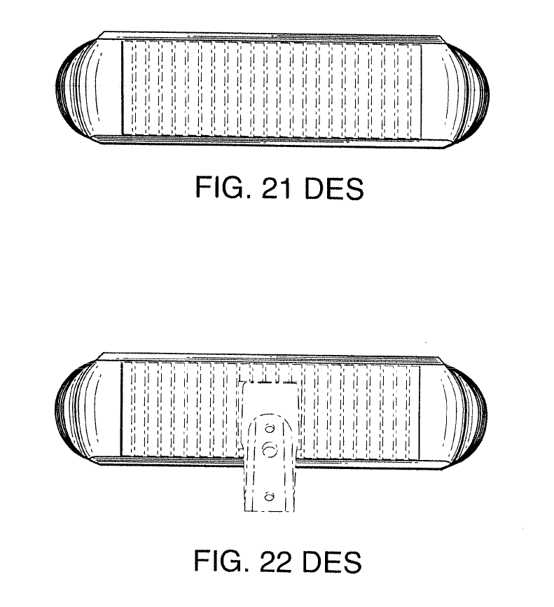

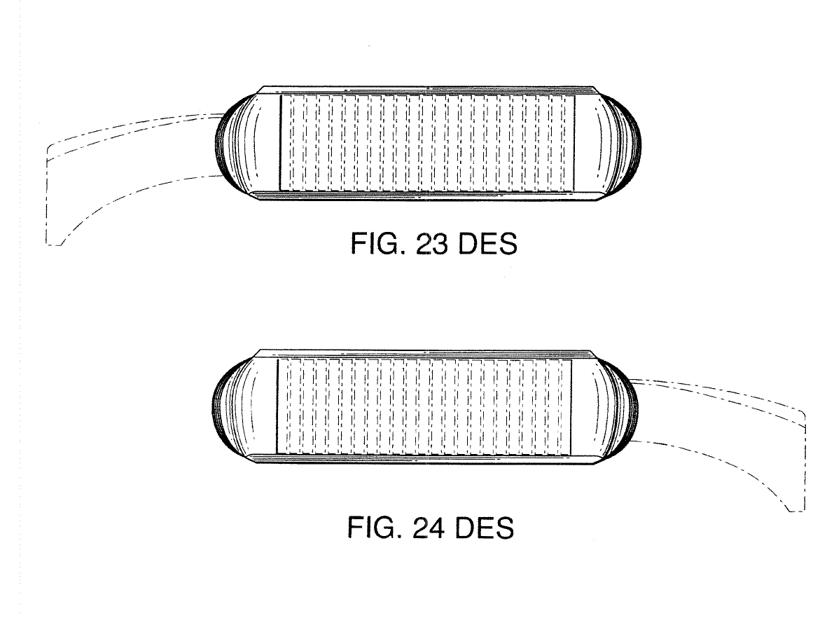

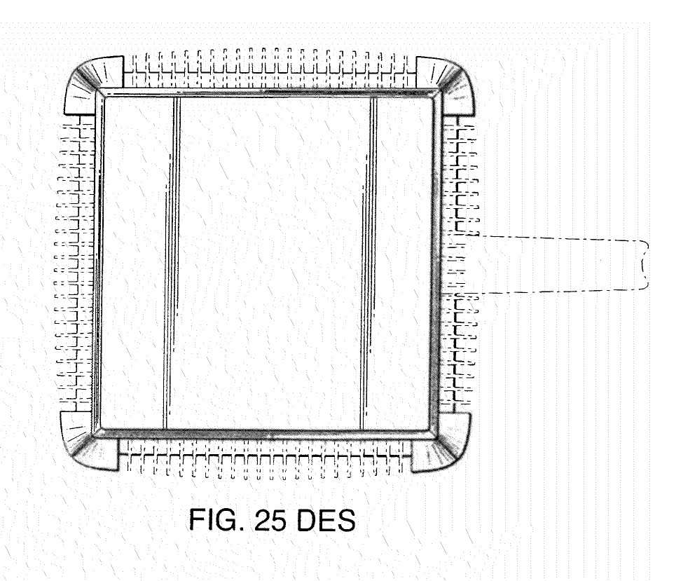

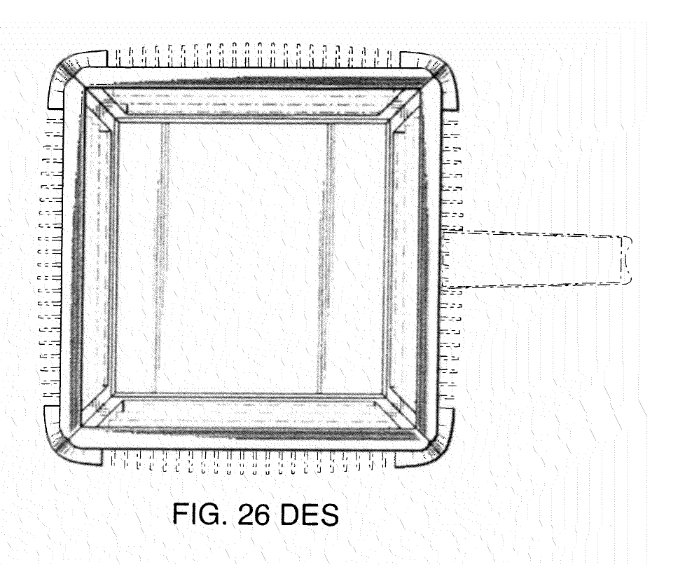

In one example of a modified light module 128, the light modules of the two side members 120 casting light in the transverse directions of the above described forward throw configuration, are modified by replacing some or all of the reflectors 160 with the alternative reflector 184 depicted in FIGS. 12A-12C, which impact the light distribution as shown by FIG. 12D, which shows the alternative reflector 184 in cross-section and the light ray traces it produces. The depicted alternative reflector 184 is the same in all respects as reflector 160, with the addition of a forward throw divider 186 located between apertures 164 to redirect some of the light emitted from the LEDs 158 protruding through the apertures 164. In the depicted embodiment, the forward throw dividers 186 are all of like configuration and are constructed of formed sheet metal. More particularly, the forward throw dividers extend upward from the base 162′ between the first and second members 166′ and 168′ angled along the sides 188 to conform to the angles of the proximate and distal angled portions 170′ and 172′. Each forward throw divider 186 further has a front face 190 and a rear face 192. The front face 190 comprises a straight proximate angled portion 194 and a straight distal angled portion 196 extending from the proximate angled portion 194 to a tip 198 of the forward throw divider 186. In the depicted embodiment, the proximate angled portion 194 extends at an angle of x (preferably 90°) from the base 162′ and the distal angled portion 196 extends at an angle of y (preferably 75°) from the base 162. The rear face 192 extends at an angle of z (preferably 45°) from the base 162′. The tip 198 preferably extends 0.53 inches from the base 162′ and the proximate angled portion preferably extends 0.21 inches from the base 162′. In this configuration, the light is directed as depicted in FIG. 12D showing light ray traces emitted from LEDs 158 and being redirected by the front and rear faces 190, 192 of the forward throw dividers 186. The angles x and y of the proximate and distal angled portions of the front face 190 redirect a sufficient number of light rays in the forward throw direction to cast sufficient lumens in that direction and create a IESNA Type FT distribution when the alternative forward throw reflector 184 is used for all three reflectors in the light modules 128 of the side members 120 casting light in the transverse directions. That is, the forward throw dividers 186 direct some of the light rays headed in the transverse direction, toward the forward throw direction. Although the redirected light rays will address the lens 152 at an angle such that some lumens will be lost due to internal reflectance, much of the light output emitted from LEDs 158 will still address the lens 152 approximately perpendicular thereto.

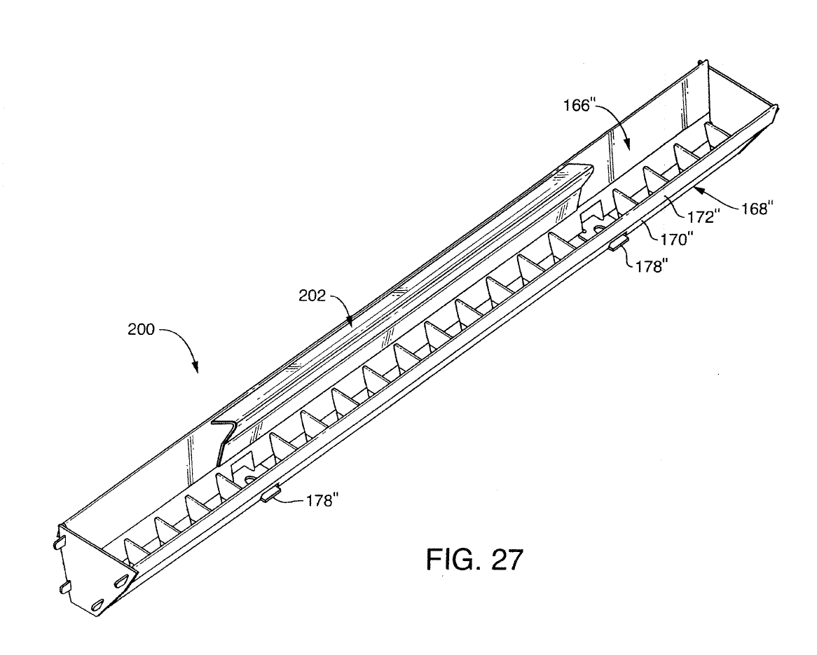

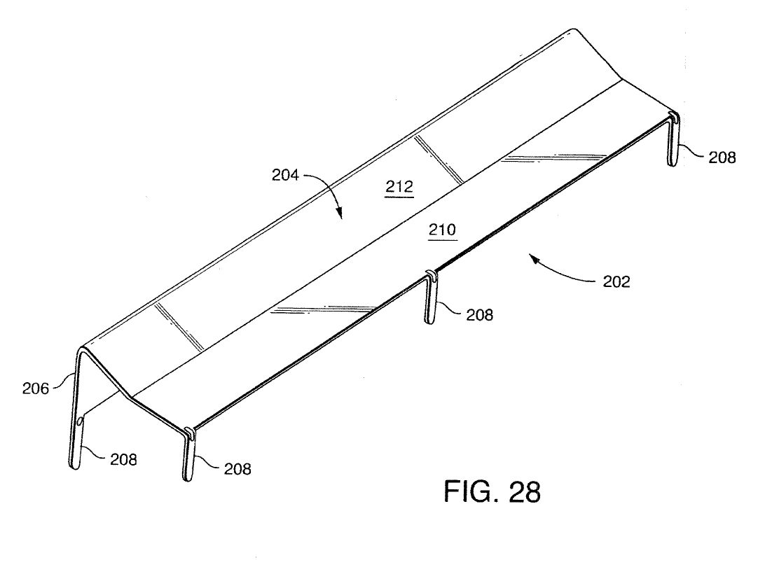

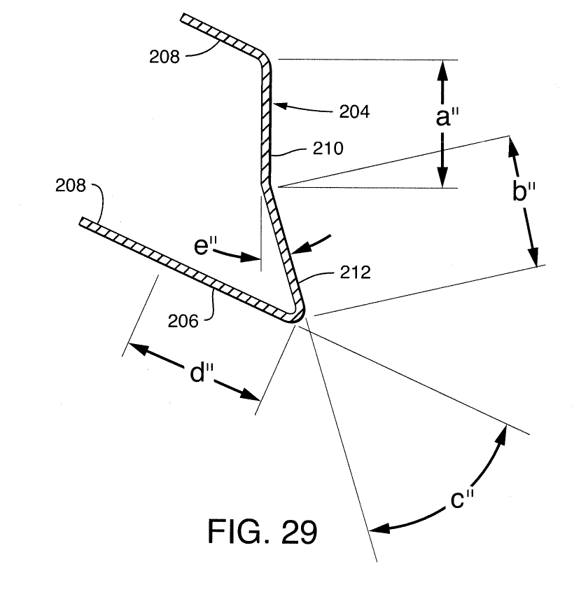

Although some light in the previously described embodiments is projected to areas immediately underneath the luminaire 100 as well as to areas adjacent thereto, in some applications of the luminaire 100, it may be desirable to direct a greater portion of the light generated by the light sources such as LEDs 158 downward to a target area immediately underneath the luminaire 100 than is generated by the previously disclosed embodiments. Directing more light downward to the target area immediately underneath the luminiare 100 can be accomplished by, for example, decreasing the angle c, changing the configurations of reflectors 160 or 184 and/or adding optical lenses to the light sources. The amount of light directed to the target area immediately underneath the luminaire 100 can be increased with an alternative reflector embodiment 200, exemplary embodiments of which are depicted in FIGS. 27-30.

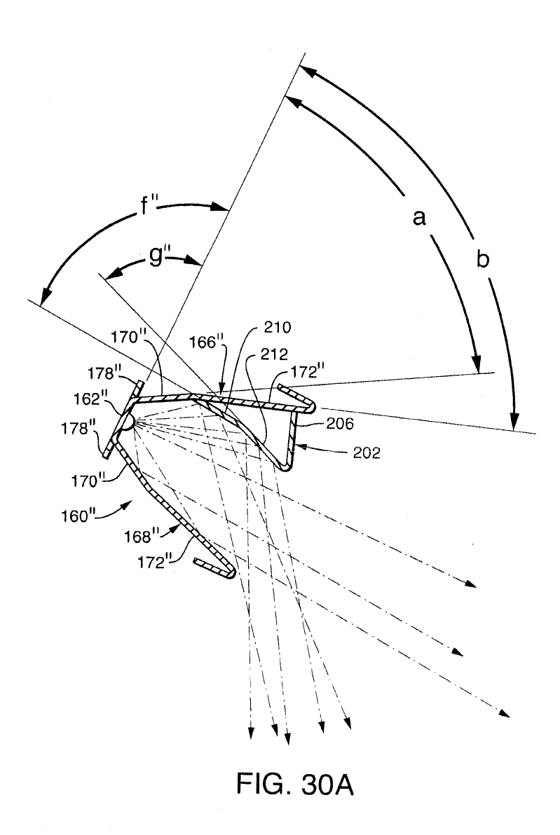

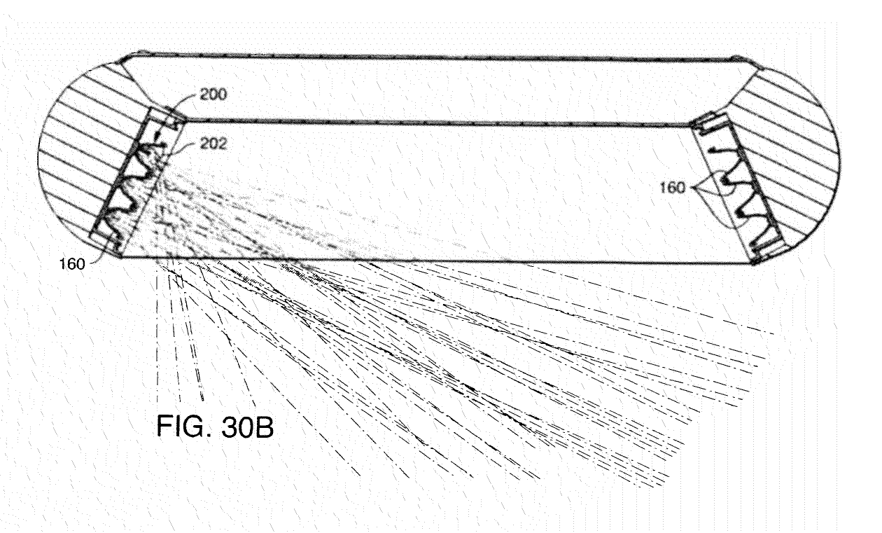

The depicted alternative reflector 200 is the same in all respects as reflector 160, with the addition of a baffle 202 located and configured to redirect some of the light emitted from the LEDs 158 downward toward the area immediately underneath the luminaire 100. In the depicted embodiment, the baffle 202 is comprised of a redirecting portion 204 and a connecting extension 206. The redirecting portion is comprised of first and second portions 210, 212. Connecting tabs 208 extend from the baffle 202 for insertion through apertures in one of the first or second members 166″, 168″ of the reflector 200. As can be seen, for example in FIGS. 30A and 30B, the baffle first portion 210 creates a relatively small angle with the first member 166″ of the reflector 200 and extends in a substantially flat manner until it meets the baffle second portion 212 which extends at an angle thereto. In one embodiment, the first redirecting portion 210 is configured to make an angle f″ of 84° with the reflector base 162″ and the second redirecting portion 212 is configured to make an angle g″ of 68° with the reflector base 162″, which results in the first redirecting portion 210 extending downward at an angle of 31° to the plane defined by the side member lower edges 180 of the luminaire 100, while the second redirecting portion 212 extends at an angle of 47° to that plane. In one embodiment, that plane is horizontal, which may be parallel to the target area immediately underneath the luminaire 100 to be lighted.

In an alternative embodiments, the first and second redirecting portions 210, 212 could be curved and the first and second portions 210, 212 could form a single continuous curve. The first and second redirecting portions 210, 212 of the baffle 202 extend from the reflector first member 166″ inward into the path of light emitted by the light source. Because the reflector first member 166″ is the uppermost of the walls of the reflector 200, the baffle extends downward from the first member 166″ such that it directs light emitted from the LEDs 158 downward toward the area immediately underneath the luminaire 100. FIGS. 30A and 30B depict light rays traces approximating the path of light emitted from the LEDs 158 as directed by the reflector 200, including the baffle 202.

The amount of light directed to the area immediately underneath the luminaire 100 depends on the angles that the first and second redirecting portions 210, 212 of the baffle 202 make with respect to the light emitted from the light sources, which in the case of the LED light source of the disclosed embodiment can be referenced by the angle those portions 210, 212 make with the reflector base 162″ which is parallel to the PCB on which the LED is created or mounted. These angles are disclosed above for the depicted embodiment. The amount of light directed to the area immediately underneath the luminaire 100 also depends on the length of the baffle 202 with respect to the extent of the light source or, in the case of LEDs or other point-sources, the length which such point-sources extend along the reflector 200′. In the depicted embodiment, the baffle 202 is shorter than the overall reflector 200, along which LEDs extend for most of its length, and the baffle 202 redirects less light than would a baffle extending along the entire length of the reflector 200. In one embodiment, the baffle 202 extends along approximately half of the length of the reflector 200. Although depicted as being used in a reflector identical to reflector 160, the baffle 202 could also be used on reflectors of other configurations such as, by way of example only, the alternative reflector 184 with forward throw dividers 186.

The baffle connecting portion 206 assists in securing the location of the redirecting portion 204. It is contemplated, however, that the baffle connecting portion 206 could be eliminated if the redirecting portion 204 is rigidly secured to the reflector in a mariner that keeps it from moving and the baffle 202 is itself rigid enough to maintain its form. Additionally, the baffle 202, or redirecting portion 204 thereof, can be integrated with the remainder of the reflector 200. In one exemplary embodiment, the reflector first member 166″, or a portion thereof, could be relocated inward to mimic the baffle redirecting portion 204. Where the length of the redirecting portion 204 is less than the length of the reflector 200, the reflector first member 166″ can be bent or formed (e.g. molded) to approximate the reflector 200 with baffle 202.

In one exemplary embodiment, the baffle 202 is comprised of the following angles and dimensions when used with a reflector 160, as previously described, in a luminaire 100, as previously described: a″=0.34 inches; b″=0.35 inches; c″=49°; d″=0.37 inches; e″=16°.

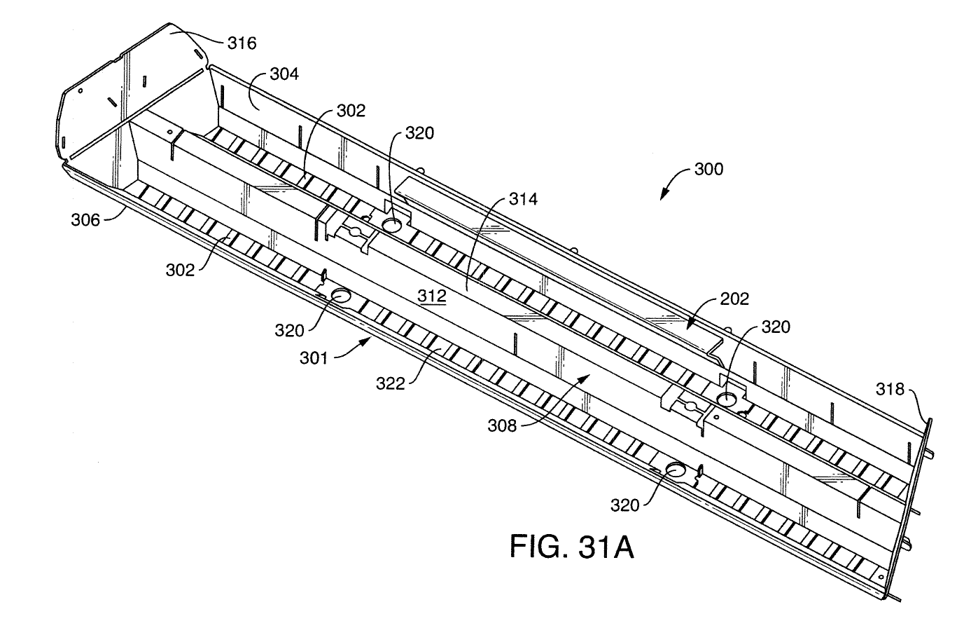

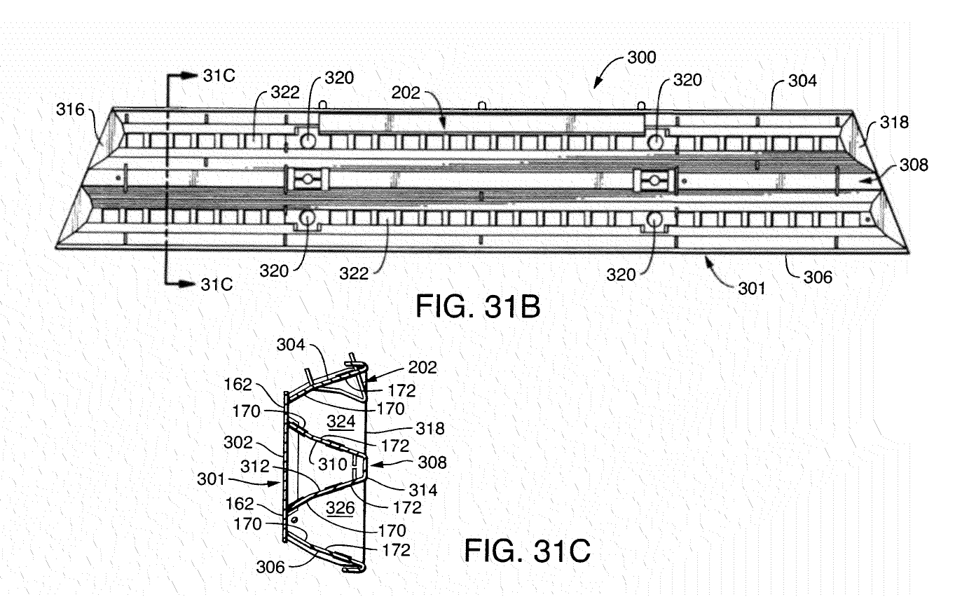

In another embodiment, one or more of the light modules 128 may include a reflector module, either alone or in conjunction with a reflector 160, 184. One such reflector module is depicted as reflector module 300 in FIGS. 31A-31C. Reflector module 300 is configured to be associated with two rows of LEDs 158 to direct the light emanating from those LEDs 158 but could be configured to be associated with one, three, four or more rows of LEDs. Reflector module 300 comprises a nest 301 having a base 302 and an upper reflector module wall 304 extending from an upper end thereof and a lower reflector module wall 306 extending from a lower end thereof. The terms “upper” and “lower” are used to describe elements of the reflector module 300 (and the other reflector module embodiments below) due to the orientation of that reflector module 300 in the intended environment of the light module 128 described herein and its orientation in the luminaire 100. However, the reflector module may also be otherwise oriented (e.g. horizontal) without departing from the scope of this invention. The base 302 defines a plurality of LED apertures 322 aligned into two lines to accommodate the two rows of LEDs 158 with which it will be associated. The base 302 further defines four mounting apertures 320 to facilitate fastening of the reflector module 300 to the light module 128 by known means. Other numbers of mounting apertures 320 or other means of mounting to the light module 128 are also contemplated. In a preferred embodiment, the nest 301 is integrally formed of a single piece of sheet metal forming a trough-like configuration. In the depicted embodiment, this trough-like configuration approximates a U-shape. This configuration leaves open ends that are closed by a first end cap 316 and second end cap 318. The reflector module 300, and any other reflector module embodiment described herein, optionally has a baffle 202 mounted to the upper wall 304.

As best depicted in FIG. 31B, the perimeter of the depicted reflector module 300 is configured as a trapezoid to fit the light module 128 of corresponding shape. As such the upper row of LED apertures 322 has fewer apertures than the lower row of LED apertures 322, as dictated by this trapezoidal shape. That shape also dictates that the reflector module upper wall 304 is shorter than the reflector module lower wall 306 and that the first end cap 316 and second end cap 318 form angles with the upper/lower walls 304, 306. Other perimeter shapes, and thus relative lengths, angles, etc., are also contemplated.

The reflector module 300 further comprises a longitudinal divider 308 secured to the base 302 and/or the first and second end caps 316, 318 in a location to divide the two rows of LED apertures 322 from one another. The longitudinal divider 308 comprises an upper wall 310 and a lower wall 312 separated by a crest 314. In the depicted embodiment, the divider 308 is configured in approximately an inverted U-shape and is situated to divide the nest 301 into two reflector troughs 324, 326, each having the same configuration and reflective properties as provided by the reflector 160 and result in the same light distribution. In particular, the base 302 of the reflector module 300 provides each reflector trough 324, 326 with a base 162; the upper wall 304 of the reflector module 300 also defines a proximate angled portion 170 and a distal angled portion 172 while the divider upper wall defines a corresponding proximate angled portion 170 and a distal angled portion 172 to define the upper reflector trough 324; and the lower wall 306 of the reflector module 300 defines a proximate angled portion 170 and a distal angled portion 172 while the divider lower wall 312 defines a corresponding proximate angled portion 170 and a distal angled portion 172 to define the lower reflector trough 326. The configuration of the upper reflector trough 324 and the lower reflector trough 326 are each approximately the same as the configuration of a reflector 106 as previously described and depicted, for example, in FIG. 9, including exemplary dimensions and angles associated therewith and provide approximately the same reflective properties and light distribution.

The reflector module 300 provides a reflector assembly replacing multiple individual reflectors 106. In the depicted embodiments, the reflector module 300 replaces two individual reflectors 106. The reflector module 300 thus decreases the number of elements for assembly producing a commensurate decrease in assembly time. The reflector module 300 also offers increase stability of the reflectors.

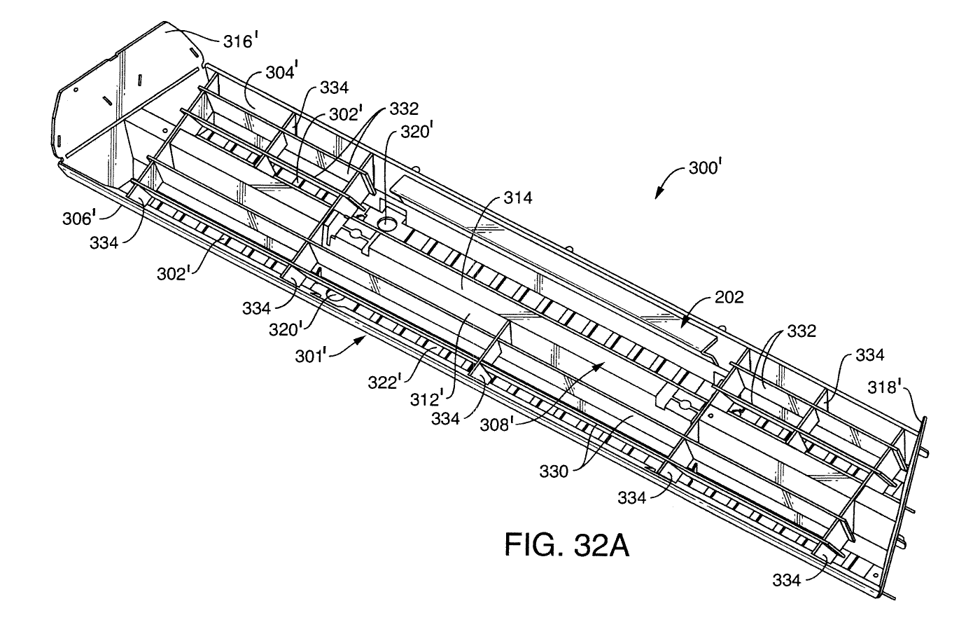

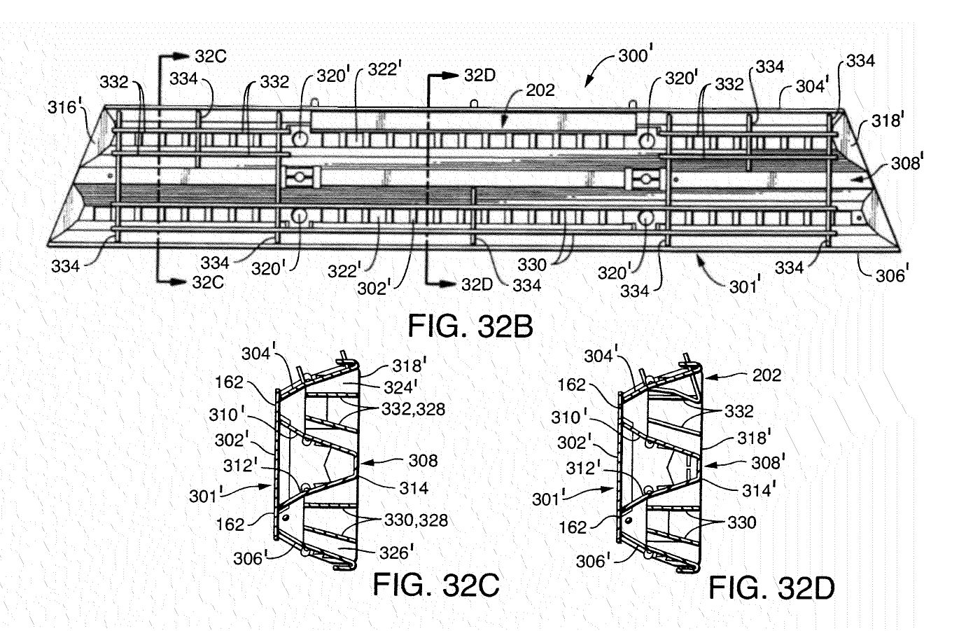

A second reflector module is depicted as reflector module 300′ in FIGS. 32A-32D. A nest 301′ and divider 308′, and thus upper and lower reflector troughs 324′ and 326′, are identical to those of the first reflector module 300 as shown and described above. The second reflector module 300′ differs from the first reflector module 300 only in that the second reflector module 300′ further provides one or more directional member 328 located over at least some of the LEDs. As best depicted in perspective view 32A and cross-sectional views 32C and 32D, the directional members 328 comprise full-length directional members 330 and focused directional members 332 and are located above certain of the LED apertures 322′. The depicted directional members 328 are flat, elongated plates located over, but spaced from, the LED apertures 322′. As will be understood, the directional members 328 may alternatively be of curved or other shape instead of flat to accomplish a desire light distribution or glare reduction. Each directional member 328 is held in such a location by two or more braces 334. In the depicted embodiment, each brace 334 is constituted by a flat plate having slots for receiving the directional members 328. The slots are of sufficient width to receive the directional members 328 in a secure fashion without adhesive or other fixing means (e.g. by force fit). The length of each brace 334 is oriented transverse to the rows of LED apertures and the plane defined by the braces 334 are oriented transverse to the plane defined by the base 302′ so that the slots open on the outermost edge of the braces 334 and extend downward to a lowermost depth of the slots, which may dictate the separation between the directional member 328 and the LED aperture 322′.

Preferably, each directional member 328 is held by at least three braces 334 to maintain the directional members 328 stable in their positioning. The braces 334 are each held in a slot of the reflector module longitudinal divider 308′, as best depicted in FIG. 32A. Braces 334 may also optionally be held in a slot in one or both of the reflector module upper wall 304′ or lower wall 306′. Other manners of securing the braces 334 to the reflector module longitudinal divider 308′ and/or upper/lower walls 304′, 306′ (e.g. folded tabs) are also contemplated.

The directional members 328 refine the direction of the light rays leaving the reflector module 300′ and thus reduce the glare associated therewith. The directional members 328 are positioned at angles to a plane defined by the base 302′, as dictated by the angle of the associated slot. In the depicted example, applied to a light module 128 for use in the disclosed luminaire 100, the upper directional member 328 in each reflector trough is normal to the plane defined by the base 302′ and the lower directional member 328 in each reflector trough forms an angle of 15° below normal to the plane defined by the base 302′. As will be understood, other angles are contemplated for each louver and the angles can differ from reflector trough to reflector trough as required by the application (e.g., light distribution pattern of the LED or other light source, angle of the reflector module 300′ to the ground, anti-glare requirements, etc.).

The directional members 328 can extend the full-length of an associated row of LEDs, such as full-length directional members 330, or any portion thereof, such as focused directional members 332. In the depicted embodiment, a directional member is associated with each LED aperture 322′ except those associated with the baffle 202. Consequently, in the depicted embodiment, the lower reflector trough 326′ has full-length directional members 330 extending over the entire row of LED apertures 322′ whereas the upper reflector trough 324′ is comprised of focused directional members 332 located over portions of the row of LED apertures 322′ adjacent to each of the first and second end caps 316′, 318′ but not between those portion, which is associated with the baffle 202.

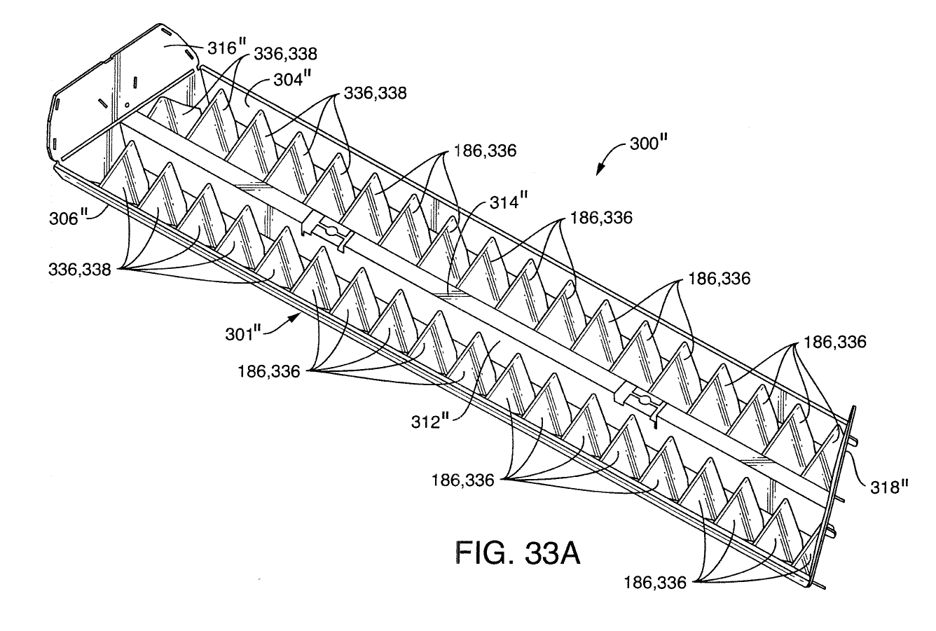

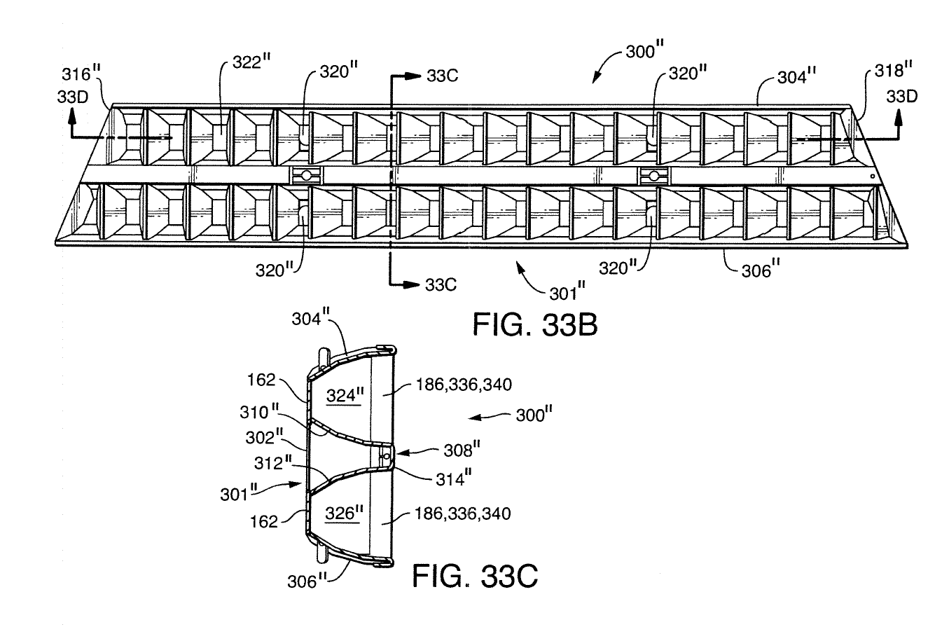

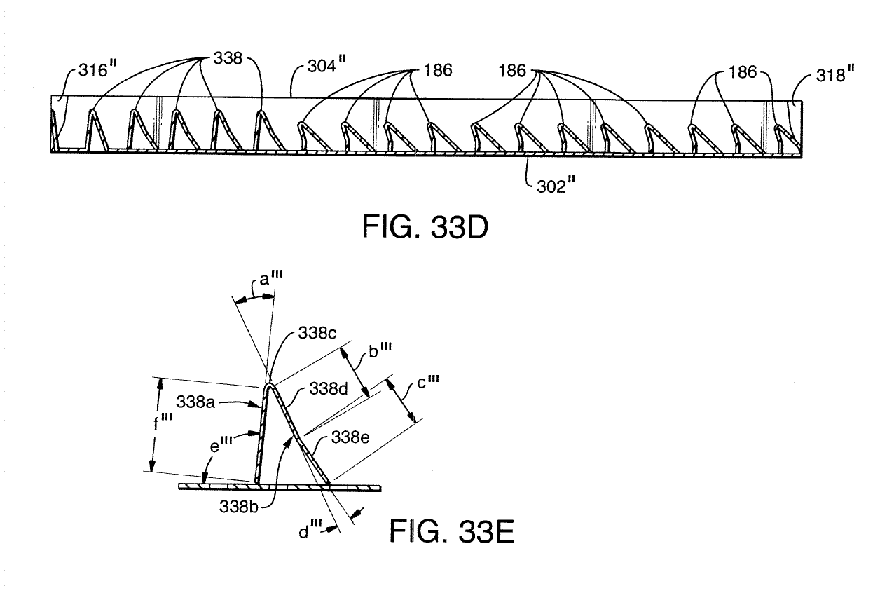

A third reflector module is depicted as reflector module 300″ in FIGS. 33A-33D. The nest 301″ and divider 308″, and thus upper and lower reflector troughs 324″ and 326″, are identical to those of the reflector module 300 as shown and described above. The third reflector module 300″ differs from the reflector module 300 only in that the third reflector module 300″ further provides one or more transverse dividers 336 located one each between the LED apertures 322″. In the embodiment depicted in FIGS. 33A-33E, a transverse divider 336 is located to the right of each LED aperture 322″. Each of the thirteen transverse dividers 336 located closest to the second end cap 318″ in each reflector trough 324″, 326″ are forward throw dividers 340 of an identical cross-sectional configuration as forward throw dividers 186 described above and depicted in FIG. 12D. The remaining transverse dividers 336 in each reflector trough 324, 326 (i.e. the five located closest to the first end cap 316″) are downward throw dividers 338 having a downward throw configuration designed to direct the light emitted from the LEDs in the adjacent LED apertures 322″ in a more downward direction than the forward throw dividers. Detail of exemplary downward throw dividers 338 are depicted in FIG. 33D and more specifically called out in FIG. 33E. With regard to FIG. 33E, the transverse divider 338 comprises a front face 338a extending up from the base 302″ (or adjacent thereto) at an angle at or approximately perpendicular to the base 302″ in order to direct light downward, a rear face 338b extending from the base 302″ (or adjacent thereto) at an acute angle thereto to a crest 338c to permit light to be directed somewhat laterally in that direction. The rear face 338b is comprised of a proximate rear face section 338e and a distal rear face section 338d. The following dimensions and angles are exemplary a″′=31′; b″′=0.428 inches; c″′=0.392 inches; d″′=9°; e″′=95′; f″′=0.691 inches. Other dimensions and angles are contemplated to direct light as desired.

By coupling the five downward throw dividers 338 with the thirteen forward throw dividers 340, the depicted third reflector module 300″ directs light from five LEDs 158 downward toward the underlying ground while the remaining forward throw dividers 340 throw light under and past the LEDs 158 projecting light downward beyond the area underlying the luminaire 100. In one application, the luminaire 100 could be place at the side of a road and the forward throw dividers 340 would direct light out into the road while the downward throw dividers 338 would direct light to the roadside underlying the luminaire 100. In another embodiment, all of the transverse dividers 336 in the reflector module 300″ could be forward throw dividers 340, or, be all downward throw dividers 338 or any combination thereof.

The transverse dividers 336 are preferably formed sheet metal. The transverse dividers 336 can be individually fixed to the base 302″ and/or upper/lower walls 304″, 306″ and/or longitudinal divider 308″ within the respective reflector troughs 324″, 326″ by tabs and slots. Alternatively, the transverse dividers 336 for each reflector trough 324″, 326″ can be all formed in a continuous strip and then fixed into the trough by fixing at two or three locations, or more, to any point of the base 302″ and/or the upper/lower walls 304″, 306″ and/or the longitudinal divider 308″. In yet another alternative, the transverse dividers 336 for each reflector trough 324″, 326″ can be all formed in a continuous strip and those strips secured to one another for simple assembly to the upper/lower troughs 324″, 326″ by fixing at two or three locations, or more, to any of the base 302″ and/or the upper/lower walls 304″, 306″ and/or the longitudinal divider 308″. In a further alternative, all or some of the transverse dividers 336 could be formed from the base 302″.

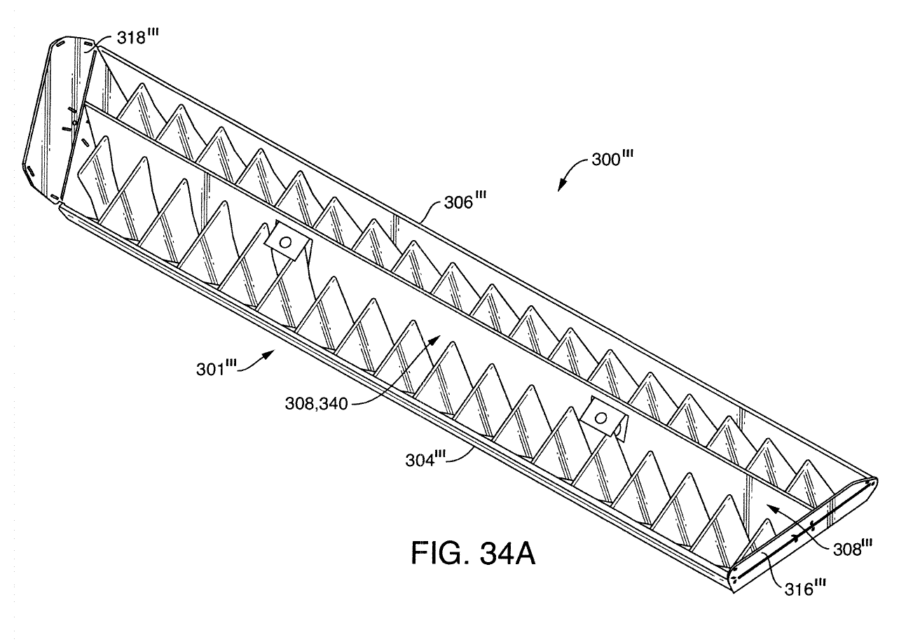

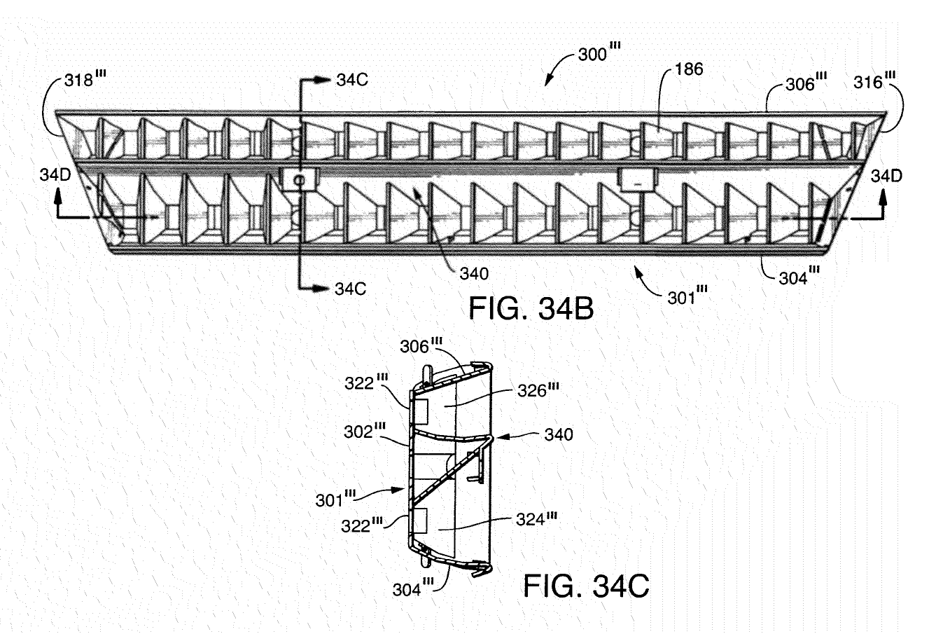

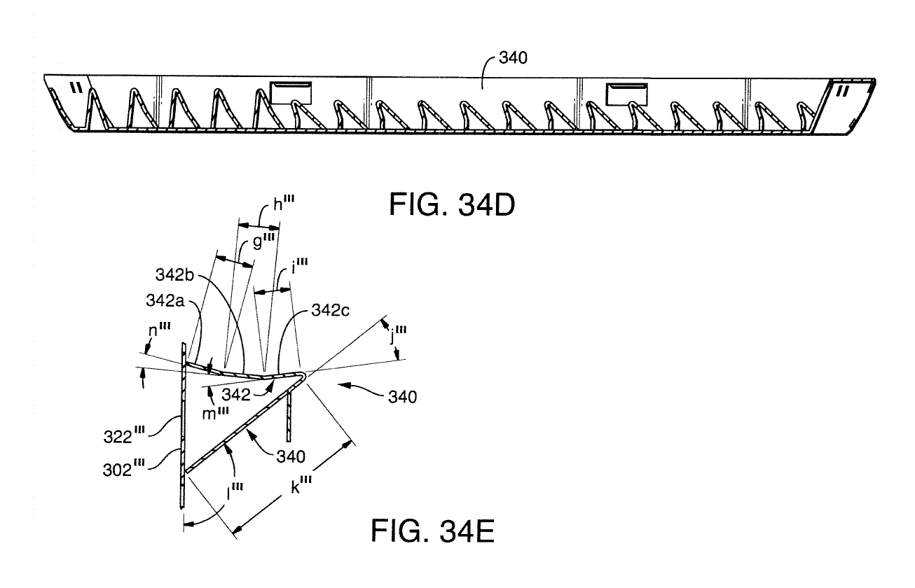

A fourth reflector module is depicted as reflector module 300′″ in FIGS. 34A-34E. The nest 301′″ and longitudinal divider 308″′, and thus upper and lower reflector troughs 324″′ and 326″′, are similar to those of the reflector module 300″′ as shown and described above and the fourth reflector module 300″′ comprises transverse dividers 336 identical to those of the third reflector module 300″ described above. The fourth reflector module 300″′ differs from the third reflector module 300″ only in that the longitudinal divider 308′″ of the fourth reflector module 300″′ is configured differently from the longitudinal divider 308″ of the reflector module 300″. The longitudinal divider 308″′ of the fourth reflector module 300″′ is depicted in FIGS. 34A-34D. The particulars of longitudinal divider 308″′ are best depicted in FIG. 34C and FIG. 34E. The longitudinal divider 308″′ of the fourth reflector module 300″′ is a downward throw divider 340, comprising a first face 342 and a straight second face 344 extending at an angle to the base 302′″ (or adjacent thereto). The first face 342 is comprised of a first straight segment 342a extending outward from the base 302″′ (or adjacent thereto) at an angle acute to normal with the base 302″′, a second straight segment 342b extending from the first segment 342a at an acute angle thereto, and a third straight segment 342c extending at an acute angle to the second segment 342b such that the second and third segments angle somewhat more toward the adjacent LED aperture 322″′ than the previous segment. The first, second and third straight segments 342a, 342b, 342c approximate a curve and, in an alternative embodiment, could be replaced by a curved face. In this manner, the downward throw divider 340, 308″′ throws light downward to send more light toward the ground underlying the luminaire 100 than would longitudinal divider 308″ of the third reflector module 300″. When the downward throw divider 340 is combined with the forward throw transverse dividers 186, the light emitted from adjacent LEDs 158 is directed both forward (toward second end cap 318″′) and downward to the ground underlying the luminaire 100.

Detail of longitudinal divider 308″′ of the fourth reflector module 300″′ is depicted in FIG. 34E. In particular, the following dimensions and angles are exemplary g″′=0.323 inches; h″′=0.346 inches; i″′=0.305 inches; j″′=31°; k″′=1.264 inches; I″′=129°; m″′=13°; n″′=10°. Other dimensions and angles are contemplated to direct light as desired.

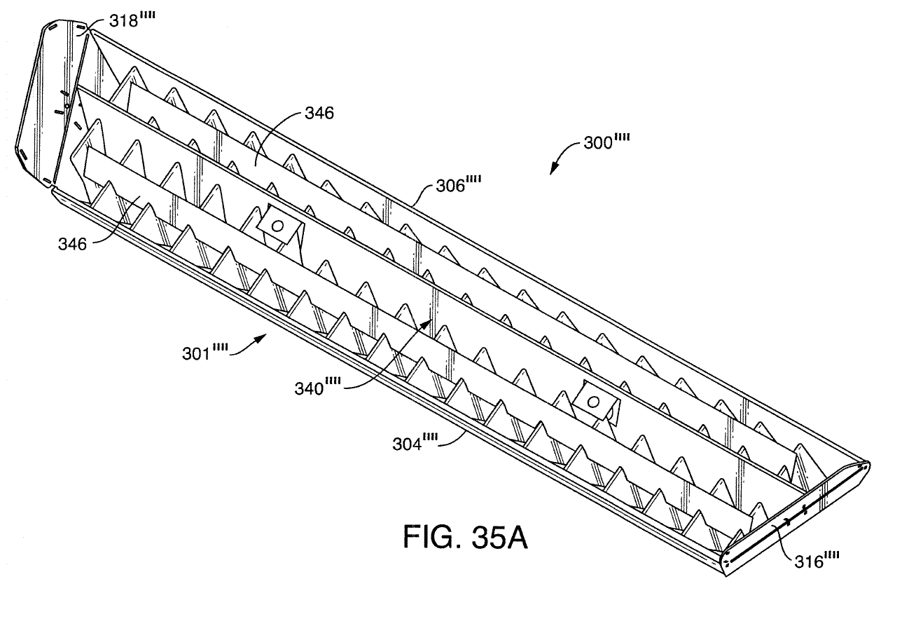

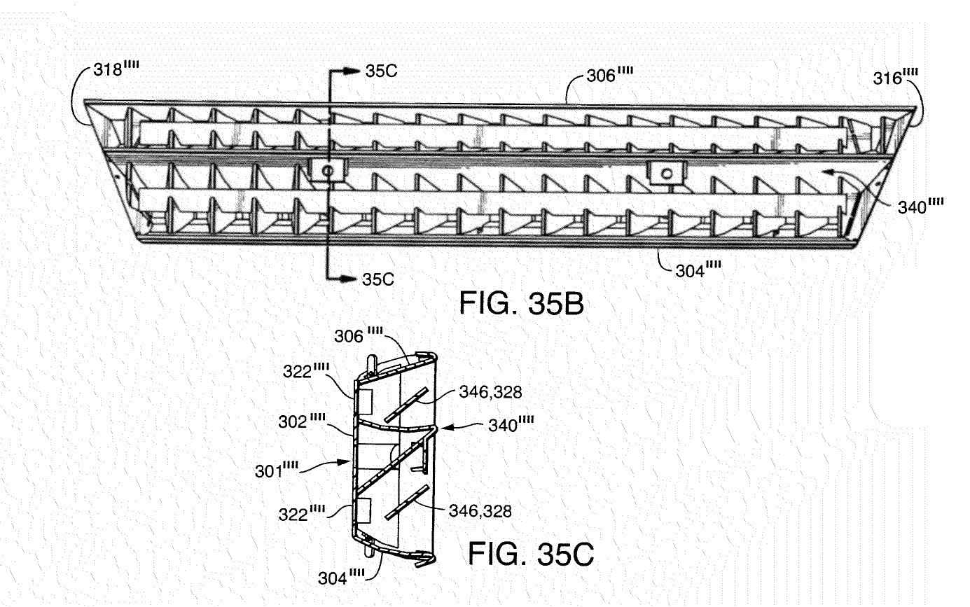

A fifth reflector module is depicted as reflector module 300″″ in FIGS. 35A-35C. The fifth reflector module 300″″ is identical to the fourth reflector module 300″′ in every way except that it comprises one directional member 346″″ located in slots in the transverse divider members 336″″ of each of the upper and lower reflector troughs 324″″, 326″″ in the same manner directional members 328 were previously discussed as being located within slots of the directional member braces 334. The directional members 346 in the depicted embodiment each form an angle of 51° above normal to the base 302″″ of the fifth reflector module 300″″. Thus configured, the fifth reflector module 300″″ will throw more light upward than the fourth reflector module 300′″ that does not comprise the directional members 346″″. Other dimensions and angles are contemplated to direct light as desired.

The versatility of the luminaire 100 is evident when considering that an assembled luminaire 100 could be converted from producing an IESNA Type V light distribution to an IESNA Type IV light distribution by simply removing one light module 128 and replacing two others with a light module having the alternative forward throw reflectors 184. Approaching the versatility from an original construction point of view, two different luminaires can be assembled using the same parts, except for the light modules 128, for which only two different configurations need be kept in inventory.

The reflector modules 300, 300′, 300″, 300″′, 300″″ likewise provide the flexibility to create different light distributions with the same luminaire 100. In particular, using the first or second reflector module 300, 300′ in all four light modules 128 of the luminaire 100 will provide an IESNA Type V light distribution. An IESNA Type IV light distribution can be obtained using the first or second reflector module 300, 300′ in a side of the luminaire 100 adjacent and running along a curb, building or other proximate boundary and the third reflector module 300″ in each of the two side of the luminaire 100 adjacent to the side with the first or second reflector module 300, 300′ configured to throw light away from the boundary. No light is projected from the remaining side of the luminaire 100. Finally, an IESNA Type IV-A light distribution can be obtained by using the same configuration as that for the Type IV distribution described immediately above, but replacing the third reflector modules 300″ with fourth or fifth reflector modules 300″′, 300″″.

The reflector 160, the alternative forward throw reflector 184, including the forward throw dividers 186, and the alternative reflector 200, including the insert 202, and first, second, third, fourth and fifth reflector modules 300, 300′, 300″, 300′″, 300″″ are preferably constructed of a sheet metal with a high reflectance such as Alanod Miro-4 Specular Aluminum. Other material are also contemplated to arrive at this configuration.

The versatility of the luminaire disclosed herein extends to nearly any light distribution desired with minor changes to the reflectors 160 and/or the addition of optic lenses. The dimensions, angles, materials, etc. described herein are indicative of the preferred embodiments disclosed herein. Many variations are contemplated to accomplish variations in performance.

Furthermore, the depicted luminaire 100 comprised of four side members 120 is only one currently preferred embodiment. Luminaires having other numbers of side members are also contemplated to accomplish a desired lumen output and light distribution. It is recognized that modifications to portions of the depicted luminaire 100, including the side members 120, would be necessary to accommodate the change in number of side members. For example, an alternative luminaire could comprise three side members configured substantially like the depicted side members 120 except that their ends 122 may need an angular adjustment to allow direct attachment of each side member end to another side member end. In a three side member configuration, the ends 122 could be angled at 60° rather than the 45° of the depicted embodiment. Alternatively, angled connectors could be inserted between the side members 120 of the depicted configuration or other configurations to provide the angle necessary to facilitate a luminaire of any number of side members desired. It is also contemplated that in addition to a luminaire of any number of side members, each of the side members could have a light module 128 of the depicted configuration or any other configuration, or no light module at all, in order to produce any light distribution desired from the luminaire as a whole.

The LEDs of this exemplary embodiment can be of any kind, color (e.g., emitting any color or white light or mixture of colors and white light as the intended lighting arrangement requires) and luminance capacity or intensity, preferably in the visible spectrum. Color selection can be made as the intended lighting arrangement requires. In accordance with the present disclosure, LEDs can comprise any semiconductor configuration and material or combination (alloy) that produce the intended array of color or colors. The LEDs can have a refractive optic built-in with the LED or placed over the LED, or no refractive optic; and can alternatively, or also, have a surrounding reflector, e.g., that re-directs low-angle and mid-angle LED light outwardly. In one suitable embodiment, the LEDs are white LEDs each comprising a gallium nitride (GaN)-based light emitting semiconductor device coupled to a coating containing one or more phosphors. The GaN-based semiconductor device can emit light in the blue and/or ultraviolet range, and excites the phosphor coating to produce longer wavelength light. The combined light output can approximate a white light output. For example, a GaN-based semiconductor device generating blue light can be combined with a yellow phosphor to produce white light. Alternatively, a GaN-based semiconductor device generating ultraviolet light can be combined with red, green, and blue phosphors in a ratio and arrangement that produces white light (or another desired color). In yet another suitable embodiment, colored LEDs are used, such are phosphide-based semiconductor devices emitting red or green light, in which case the LED assembly produces light of the corresponding color. In still yet another suitable embodiment, the LED light board may include red, green, and blue LEDs distributed on the printed circuit board in a selected pattern to produce light of a selected color using a red-green-blue (RGB) color composition arrangement. In this latter exemplary embodiment, the LED light board can be configured to emit a selectable color by selective operation of the red, green, and blue LEDs at selected optical intensities. Clusters of different kinds and colors of LED is also contemplated to obtain the benefits of blending their output.

Although the embodiments described herein use LEDs to generate light rays, other light sources are also contemplated. The disclosed luminaire is not limited to use of LEDs.

While certain embodiments have been described herein, it will be understood by one skilled in the art that the methods, systems, and apparatus of the present disclosure may be embodied in other specific forms without departing from the spirit thereof. For example, while aspects and embodiments herein have been described in the context of certain applications, the present disclosure is not limited to such; for example, embodiments of the present disclosure may be utilized generally for any light distribution applications.

Accordingly, the embodiments described herein, and as claimed in the attached claims, are to be considered in all respects as illustrative of the present disclosure and not restrictive.

What is claimed is:

1. A reflector module for association with light sources in a luminaire, the reflector module comprising:
a nest comprising a base, an upper reflector module wall and a lower reflector module wall defining a longitudinal trough-like configuration;
the base defining a first row of light source apertures and a second row of light source apertures;
a U-shaped longitudinal divider located between the first row of light source apertures and the second row of light source apertures, defining a first reflector trough and a second reflector trough in the nest.

2. The reflector module of claim 1 wherein the longitudinal divider comprises a straight upper wall adjacent to the first reflector trough, a straight lower wall adjacent to the second reflector trough and a straight crest connecting the longitudinal divider straight upper wall and the longitudinal divider straight lower wall.

3. The reflector module of claim 1 wherein the base further defines a third row of light source apertures and a second longitudinal divider located between the second row of light source apertures and the third row of light source apertures, defining a third reflector trough in the nest.

4. The reflector module of claim 1 wherein the longitudinal divider is inverted such that the open end of the U-shape is directed toward the base of the nest.

5. The reflector module of claim 1 wherein a first face of the longitudinal divider defines or approximates a curve directed toward the first row of light source apertures.

6. The reflector module of claim 1 further comprising a transverse divider between one or more adjacent pairs of light source apertures and extending from adjacent to the U-shaped longitudinal divider and the upper reflector module wall.

7. The reflector module of claim 6 wherein the transverse divider comprises a front face defining or approximating a curve to direct at least some light emitted from a light source located in the adjacent light source aperture back in the direction of the light source aperture.

8. The reflector module of claim 6 wherein the transverse divider comprises an approximately straight face oriented approximately perpendicular to the base of the nest.

9. The reflector module of claim 7 wherein a further transverse divider comprises an approximately straight face oriented approximately perpendicular to the base of the nest.

10. A luminaire comprising:
light sources;
one or more side members, each side member comprising a reflector module for association with the light sources, the reflector module comprising:
a nest comprising a base, an upper reflector module wall and a lower reflector module wall defining a longitudinal trough-like configuration;
the base defining a first row of light source apertures and a second row of light source apertures;
a U-shaped longitudinal divider located between the first row of light source apertures and the second row of light source apertures, defining a first reflector trough and a second reflector trough in the nest.

11. The luminaire of claim 10 wherein the longitudinal divider comprises a straight upper wall adjacent to the first reflector trough, a straight lower wall adjacent to the second reflector trough and a straight crest connecting the longitudinal divider straight upper wall and the longitudinal divider straight lower wall.

12. The luminaire of claim 10 wherein the base further defines a third row of light source apertures and a second longitudinal divider located between the second row of light source apertures and the third row of light source apertures, defining a third reflector trough in the nest.

13. The luminaire of claim 10 wherein the longitudinal divider is inverted such that the open end of the U-shape is directed toward the base of the nest.

14. The luminaire of claim 10 wherein a first face of the longitudinal divider defines or approximates a curve directed toward the first row of light source apertures.

15. The luminaire of claim 10 further comprising a transverse divider between one or more adjacent pairs of light source apertures and extending from adjacent to the U-shaped longitudinal divider and the upper reflector module wall.

16. The luminaire of claim 15 wherein the transverse divider comprises a front face defining or approximating a curve to direct at least some light emitted from a light source located in the adjacent light source aperture back in the direction of the light source aperture.

17. The luminaire of claim 15 wherein the transverse divider comprises an approximately straight face oriented approximately perpendicular to the base of the nest.

18. The luminaire of claim 16 wherein a further transverse divider comprises an approximately straight face oriented approximately perpendicular to the base of the nest.

19. A method of manufacturing a luminaire comprising the steps of:
providing a group of side members comprising at least a first side member and a second side member;
selecting a light distribution pattern for the luminaire;
selecting a first reflector module for association with light sources of the first side member to produce a first light distribution;
selecting a second reflector module for association with light sources of the second side member to produce a second light distribution different than the first light distribution;
assembling the group of side members such that the light distributions of the group of side members combines to approximate the selected light distribution pattern.

20. The method of claim 19, wherein the step of selecting a first reflector module for association with light sources of the first side member to produce a first light distribution constitutes selecting a first reflector module that would produce an IESNA Type 5 light distribution, and the step of selecting a second reflector module for association with light sources of the second side member to produce a second light distribution different than the first light distribution constitutes selecting a second reflector module that would produce an IESNA Type forward throw distribution.

21. The method of claim 19, wherein the step of providing a group of side members comprising at least a first side members and a second side member comprises providing a first side member a second side member and a third side member, the step of selecting a first reflector module for association with light sources of the first side member to produce a first light distribution constitutes selecting a first reflector module that would produce an IESNA Type 5 light distribution, and the step of selecting a second reflector module for association with light sources of the second side member to produce a second light distribution different than the first light distribution constitutes selecting a second reflector module that would produce an IESNA Type forward throw distribution, and further comprising the step of selecting a third reflector module for association with light sources of the third side member to produce an IESNA Type forward throw distribution.

22. The method of claim 21 further comprising selecting a forward throw area not underlying the luminaire to receive light from the luminaire and locating the first reflector module opposite to the forward throw area.

23. The method of claim 21, wherein the step of providing a group of side members comprising at least a first side members and a second side member comprises providing a first side member a second side member, a third side member and a fourth side member and further comprising the step providing no light distribution from the fourth side member.
